(19) United States
(12) Patent Application Publication
(10) Pub. No.: US 2010/0046471 A1
(43) Pub. Date: Feb. 25, 2010

(54) COMMUNICATION SYSTEM, COMMUNICATION APPARATUS, WIRELESS BASE STATION, AND WIRELESS TERMINAL STATION

(75) Inventors: Hiroshi Hattori, Tokyo (JP); Toshinori Hori, Tokyo (JP); Toshiaki Tomisawa, Tokyo (JP); Yoshihiko Shirokura, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, TOKYO (JP)

(21) Appl. No.: 12/524,168

(22) PCT Filed: Feb. 6, 2007
(86) PCT No.: PCT/JP07/51982

§ 371 Date: Jul. 23, 2009

(51) Int. Cl. H04W 36/00

(52) U.S. Cl. 370/331

(57) ABSTRACT

A downlink data frame addressed to a terminal is copied and obtained downlink data frames are transmitted through different APs, respectively. When a plurality of same uplink data frames are received through the different APs, any one uplink data frame selected out of the uplink data frames is transmitted to its destination. An uplink data frame received from the terminal is copied and obtained uplink data frames are transmitted through different STAs, respectively. When a plurality of same downlink data frames are received through different STAs, any one downlink data frame selected out of the downlink data frames is transmitted to the terminal.

### TECHNICAL FIELD

The present invention relates to a wireless communication technology in a mobile communication network, and more particularly, to a network diversity communication that realizes a seamless handover.

### BACKGROUND ART

As a conventional technology for realizing a seamless communication (handover) of a terminal apparatus in a wireless communication system, for example, there are technologies disclosed in Patent Documents 1 and 2. In the technology disclosed in Patent Document 1, registration information of a terminal apparatus is exchanged between adjacent routers and a seamless movement of the terminal apparatus is realized by using the exchanged information. In the technology disclosed in Patent Document 2, encapsulation and decapsulation of data are performed by using a dynamically allocatable address such as an IP address to realize a seamless movement of a terminal apparatus.

Patent Document 1: Japanese Patent Application Laid-open No. 2004-533790
Patent Document 2: Japanese Patent Application Laid-open No. 2003-244207

### DISCLOSURE OF INVENTION

### Problem to be Solved by the Invention

However, the conventional technology for realizing a seamless communication is a reference to a procedure of seamless movement from a single communication path to another single communication path and is a reference to a procedure of an access router for managing a seamless movement through an encapsulation of a network layer such as the IP. Therefore, no solution is found concerning a seamless movement of a terminal apparatus through a plurality of communication paths and a seamless movement in a wide Ethernet (registered trademark) network and the like of a data link layer that does not require a network-layer apparatus.

The present invention has been achieved in view of the above aspects and it is an object of the present invention to obtain a communication system, a communication apparatus, a wireless base station, and a wireless terminal station that realize a seamlessness communication through a plurality of communication paths and a seamless movement of a terminal apparatus in an existing network of a data link layer.

### Means for Solving Problem

To solve the above problems and to achieve the object, a communication system according to the present invention includes a plurality of wireless base stations, a first network diversity apparatus connected to the wireless base stations, and a mobile including a plurality of wireless terminal stations connected to any one of the wireless base stations by wireless and connected to a single terminal apparatus by wire and a second network diversity apparatus connected to the wireless terminal stations. The first network diversity apparatus includes a downlink-data-frame copying and transmitting unit that copies a downlink data frame addressed to the terminal apparatus and transmits downlink data frames obtained by the copying processing to the terminal apparatus through different base stations, respectively, and an uplink-data-frame selecting and transmitting unit that transmits, when a plurality of uplink data frames having same content are received through different wireless base stations, respectively, any one uplink data frame selected out of the uplink data frames to a destination thereof. The second network diversity apparatus includes an uplink-data-frame copying and transmitting unit that copies an uplink data frame received from the terminal apparatus and transmits uplink data frames obtained by the copying processing to a destination thereof through different wireless terminal stations, respectively, and a downlink-data-frame selecting and transmitting unit that transmits, when a plurality of downlink data frames having same content are received through different wireless terminal stations, respectively, any one downlink data frame selected out of the downlink data frames to the terminal apparatus.

### Effect of the Invention

In a transmission operation for an uplink data frame, a communication system according to the present invention copies a data frame in an ND apparatus (a network diversity apparatus) on a mobile side. On the other hand, in transmission operation for a downlink data frame, the communication system copies a data frame in an ND apparatus on a stationary network side. The communication system transmits the same data frames (data frames including the same data) to the opposed ND apparatus via a plurality of wireless communication paths. The ND apparatus that receives a plurality of the same data frames selects one of the same data frames and delivers the selected data frame to a destination. As a result, as long as at least one wireless communication path is secured, it is possible to prevent an instantaneous breakage of data and to realize a communication system that does not cause a discomfort to a user.

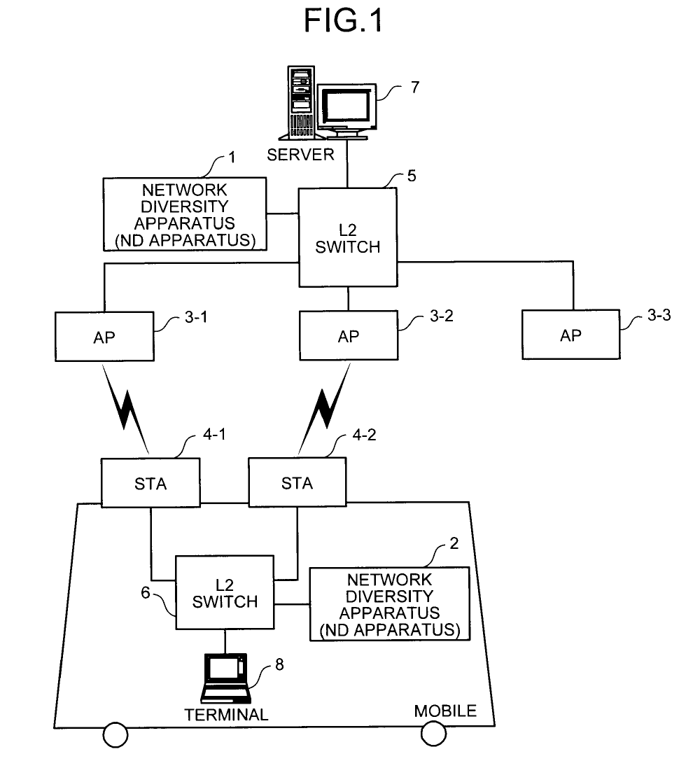

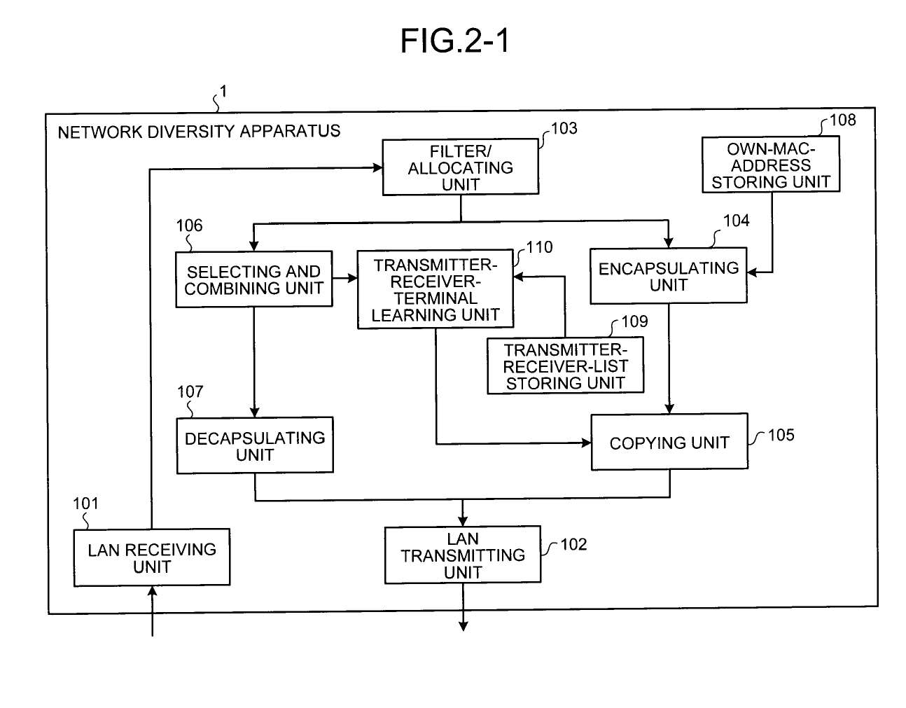

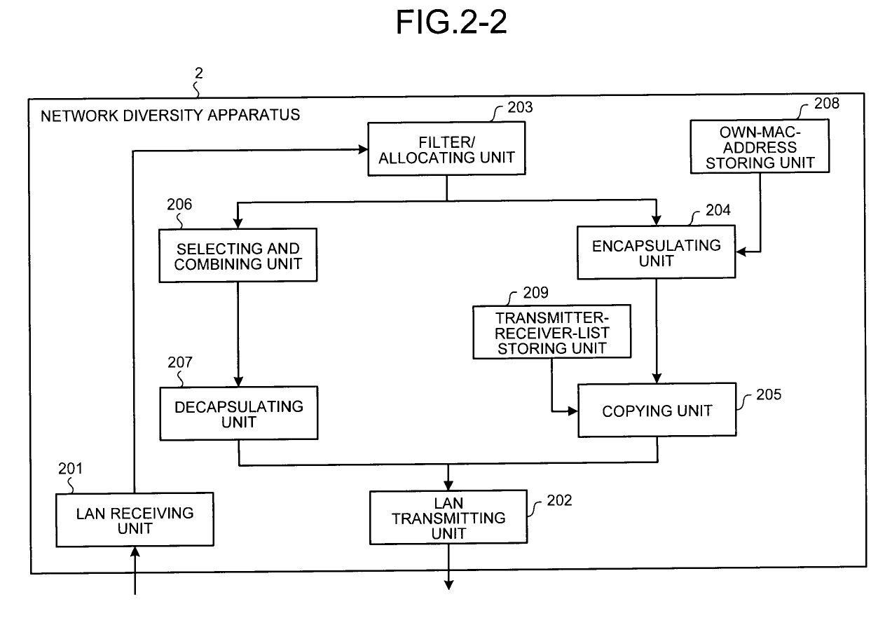

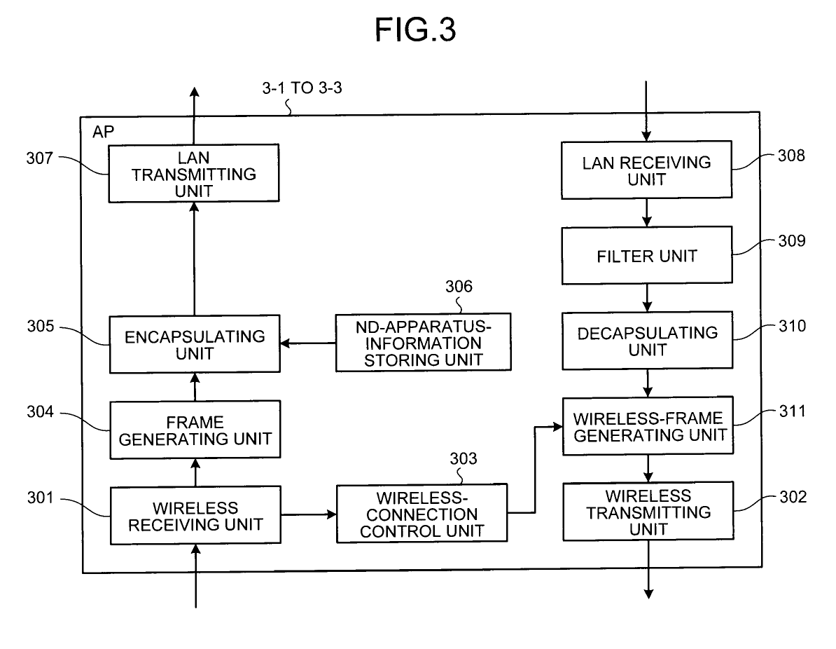

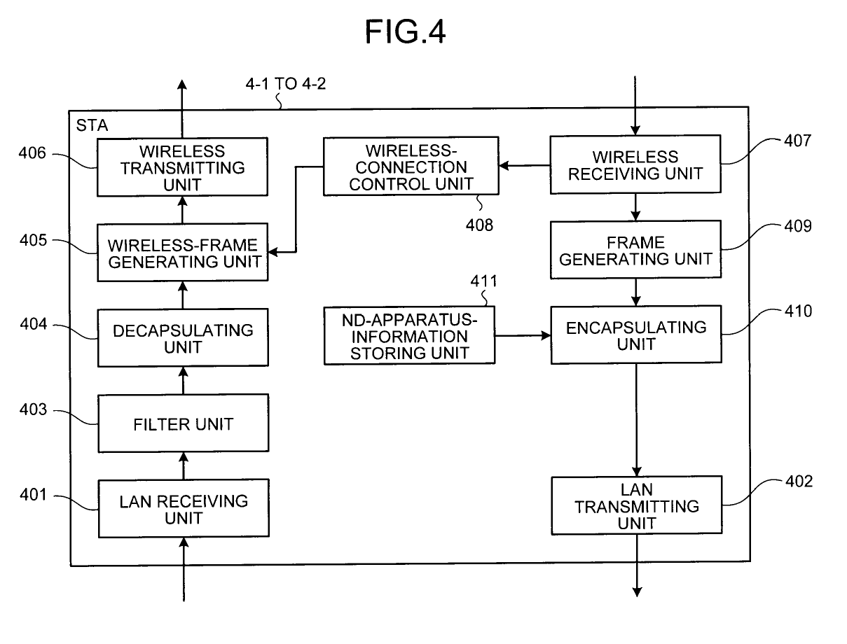

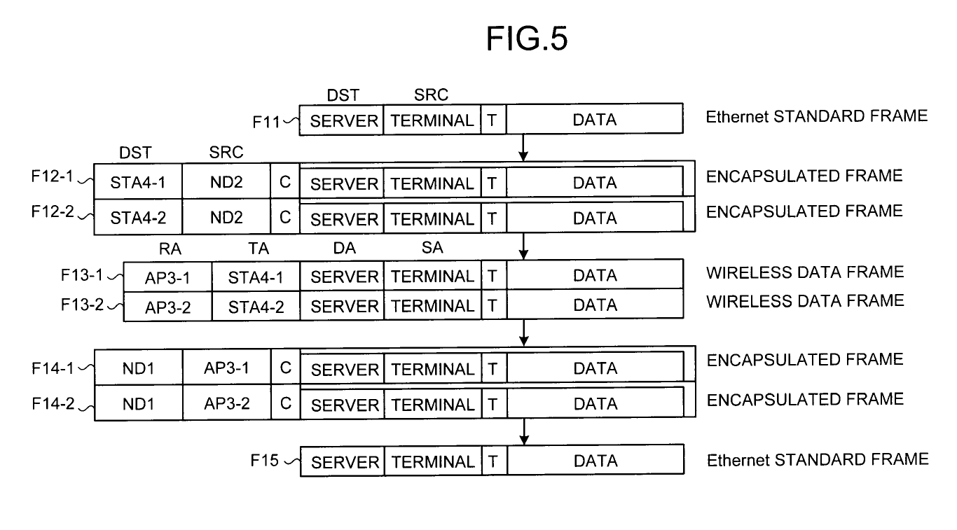

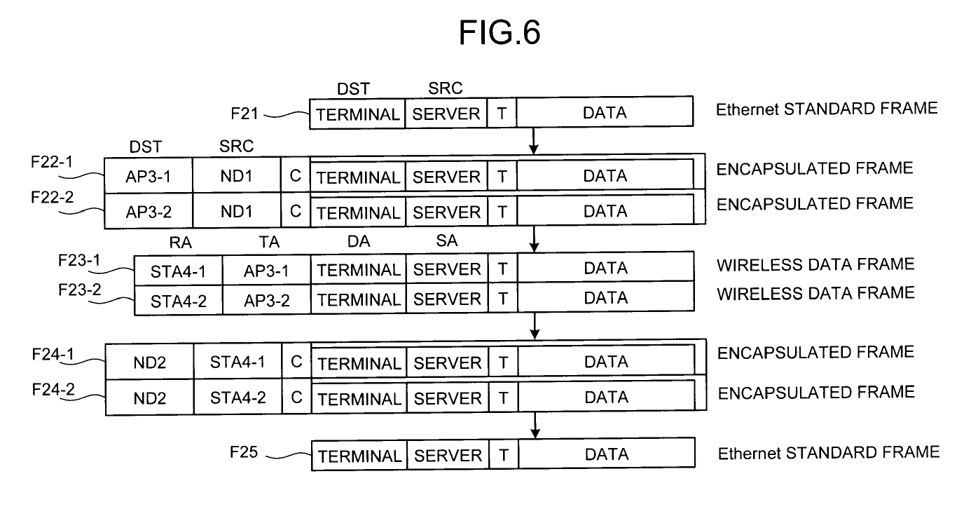

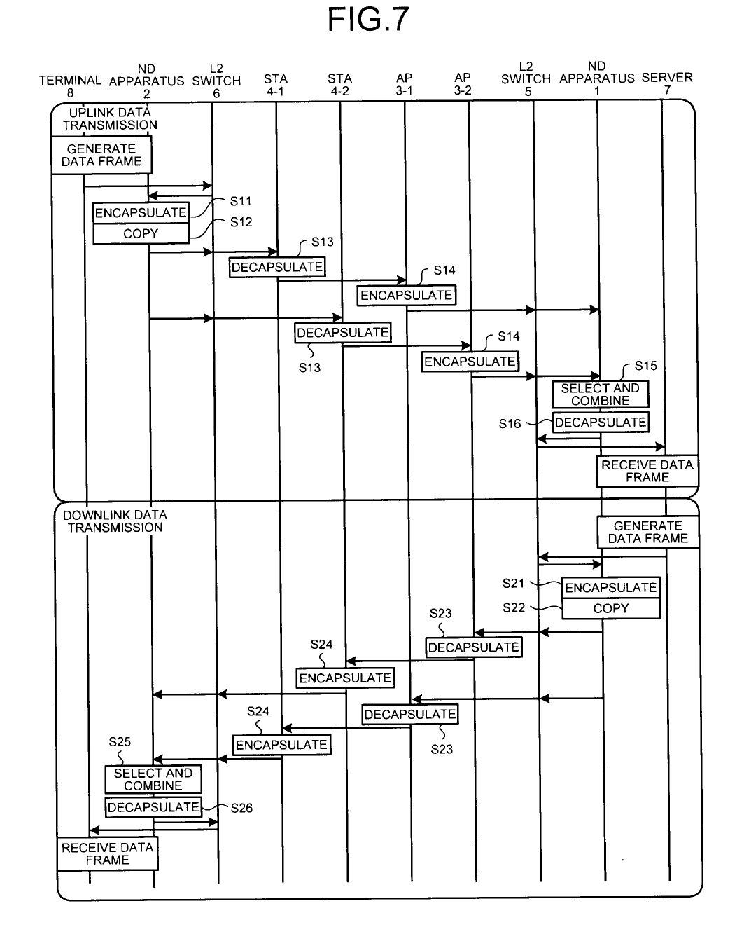

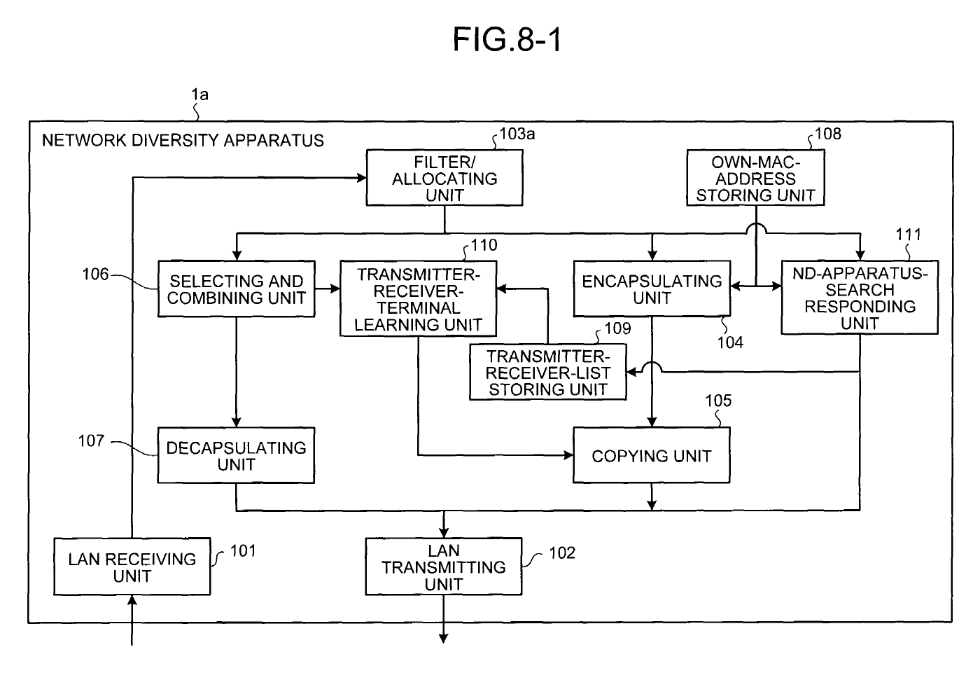

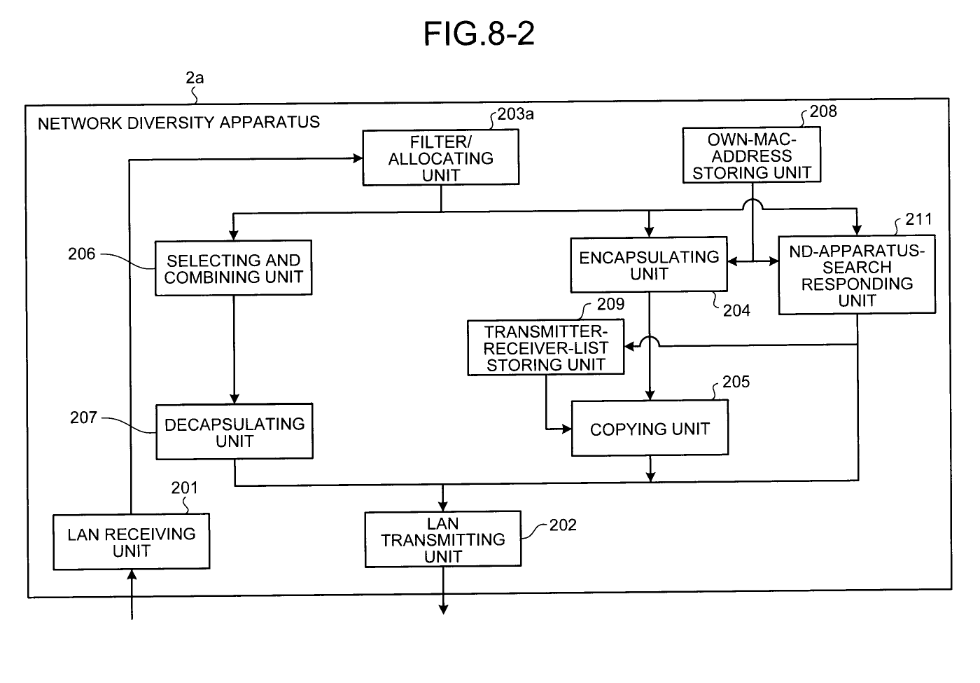

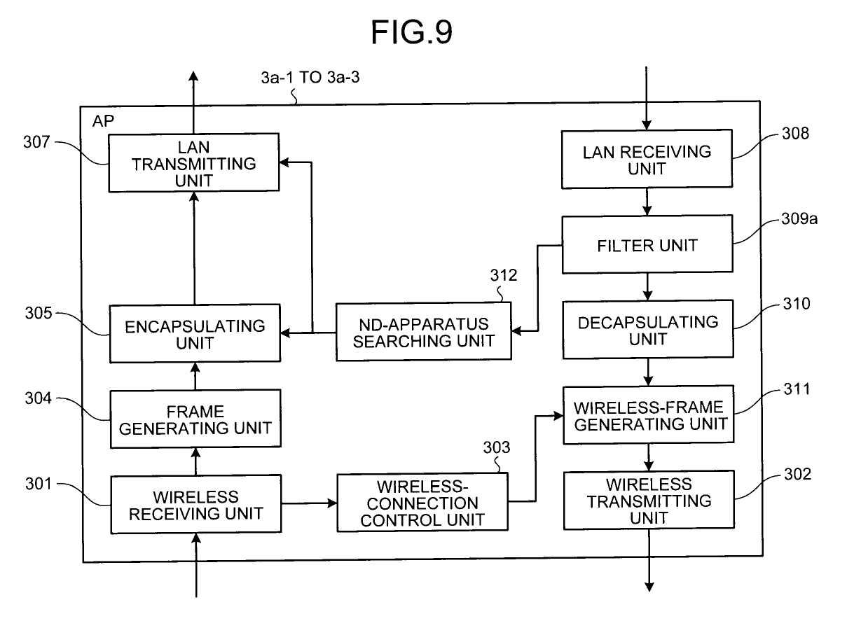

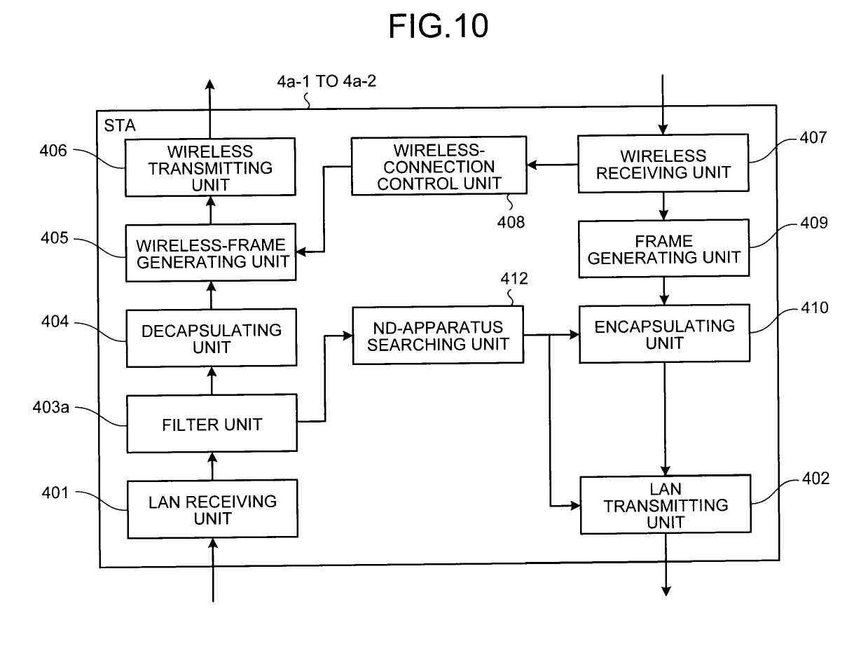

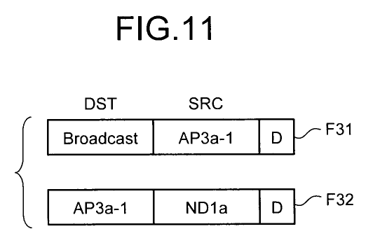

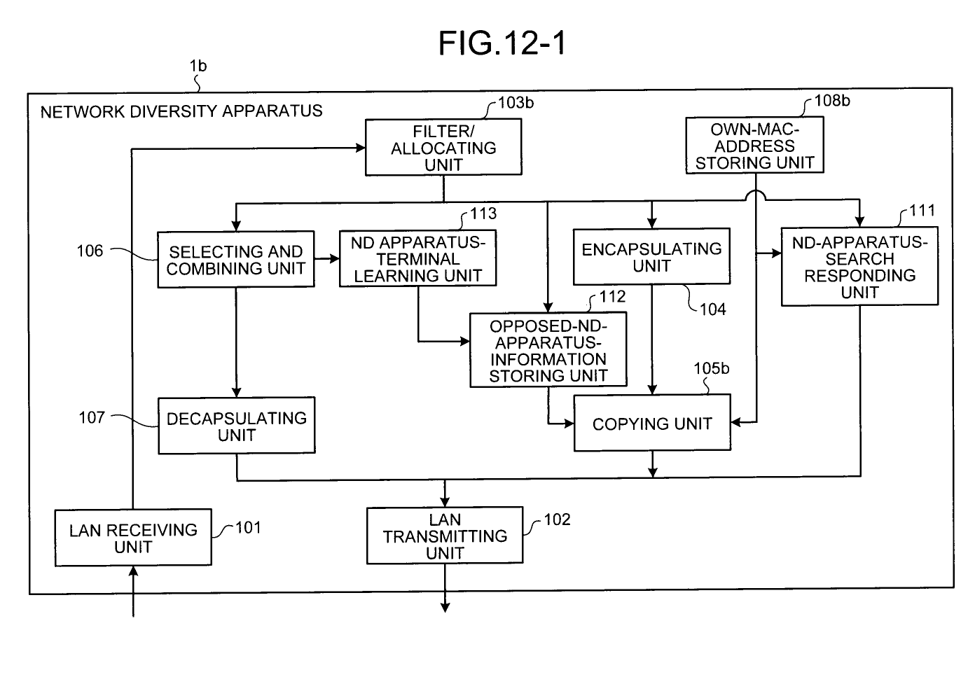

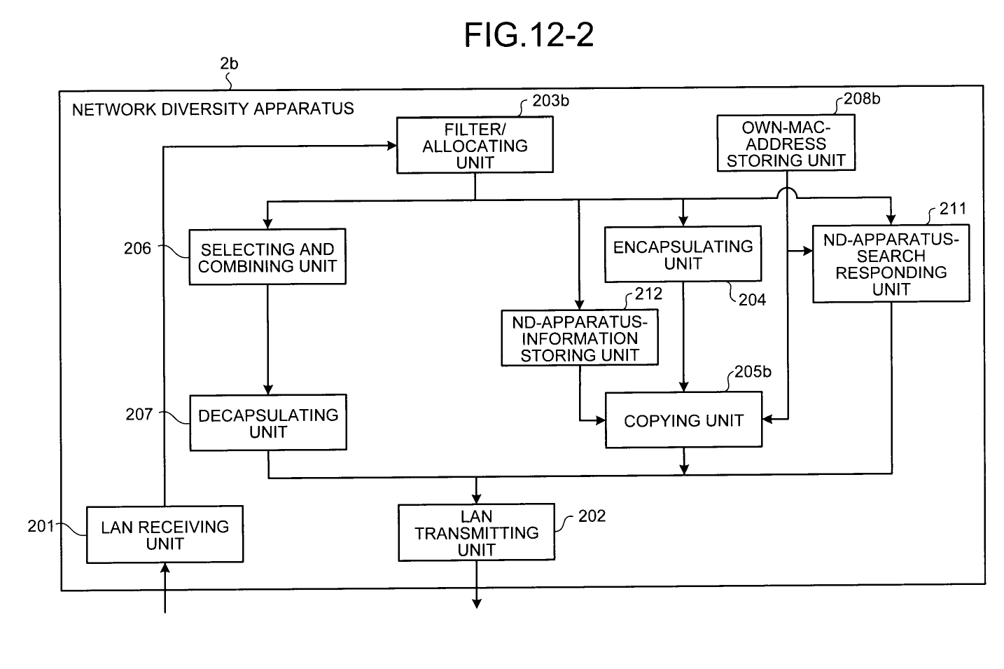

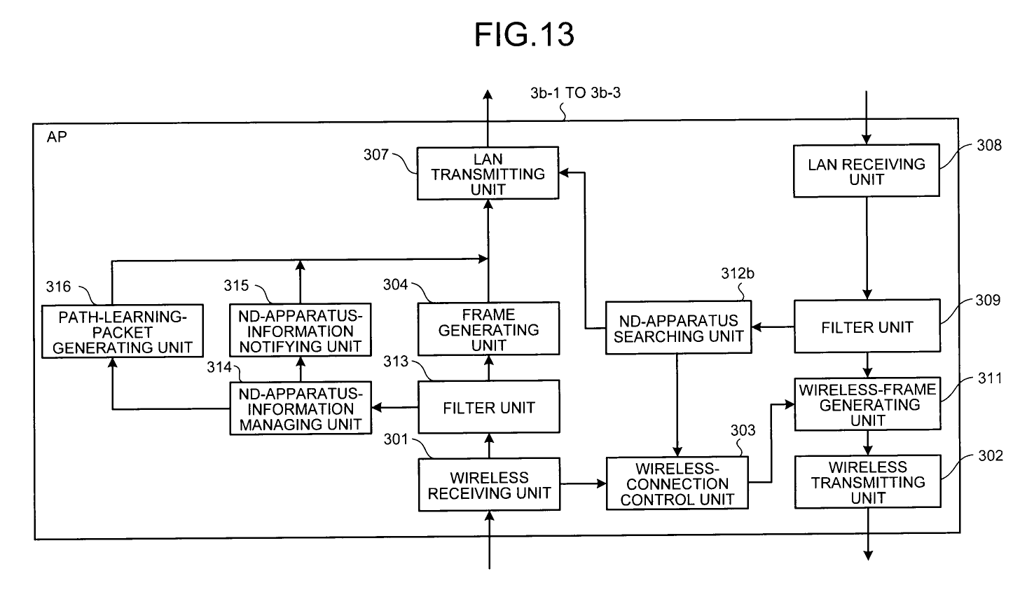

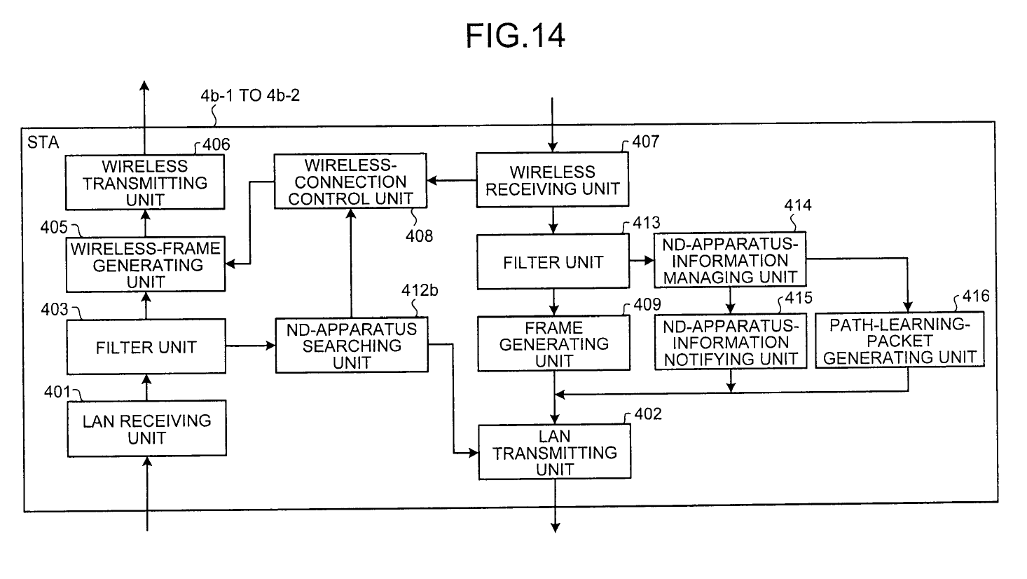

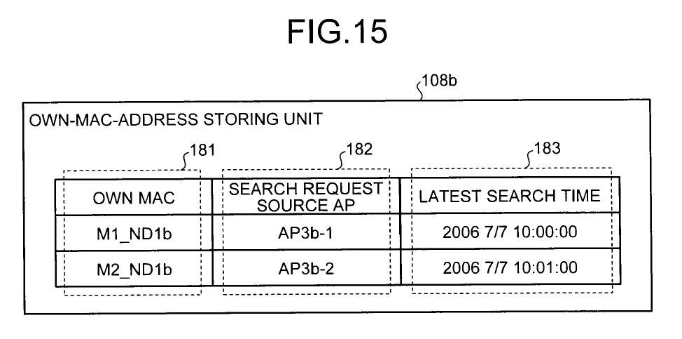

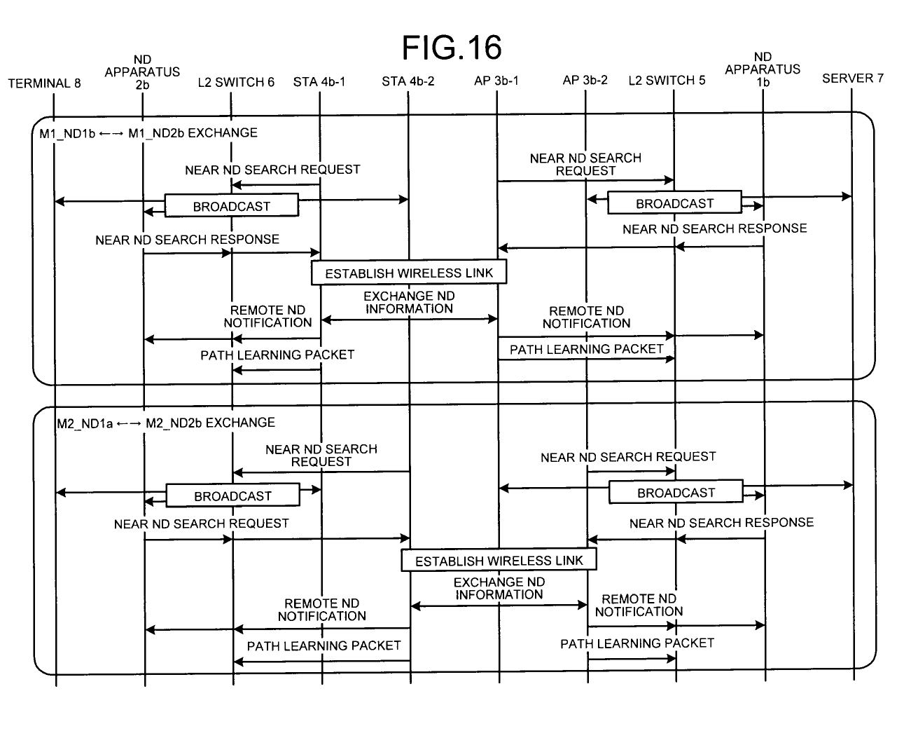

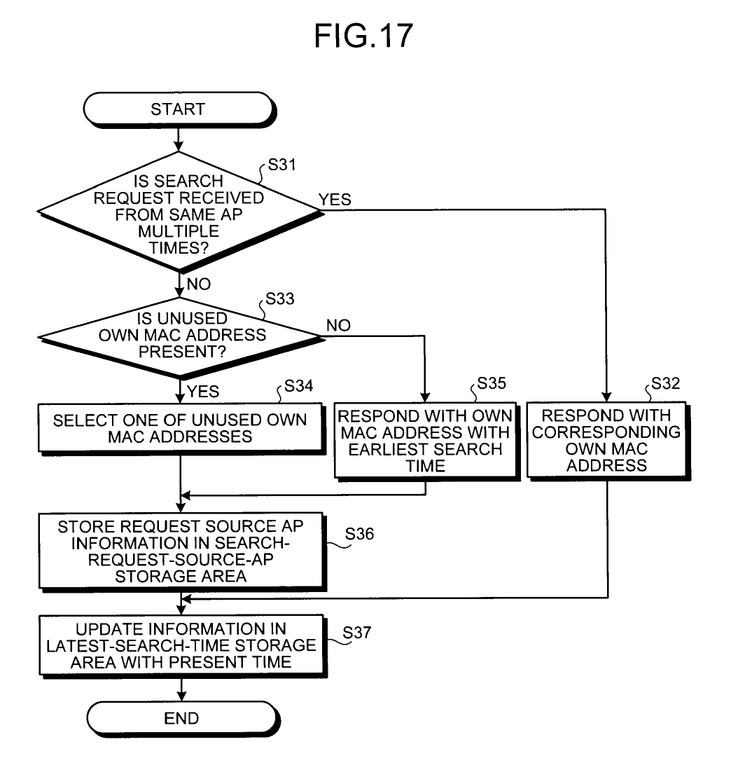

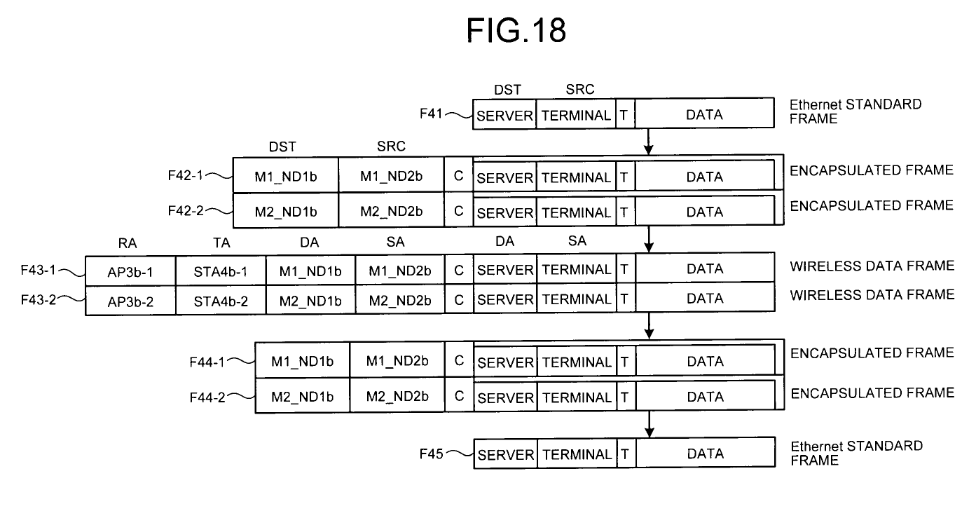

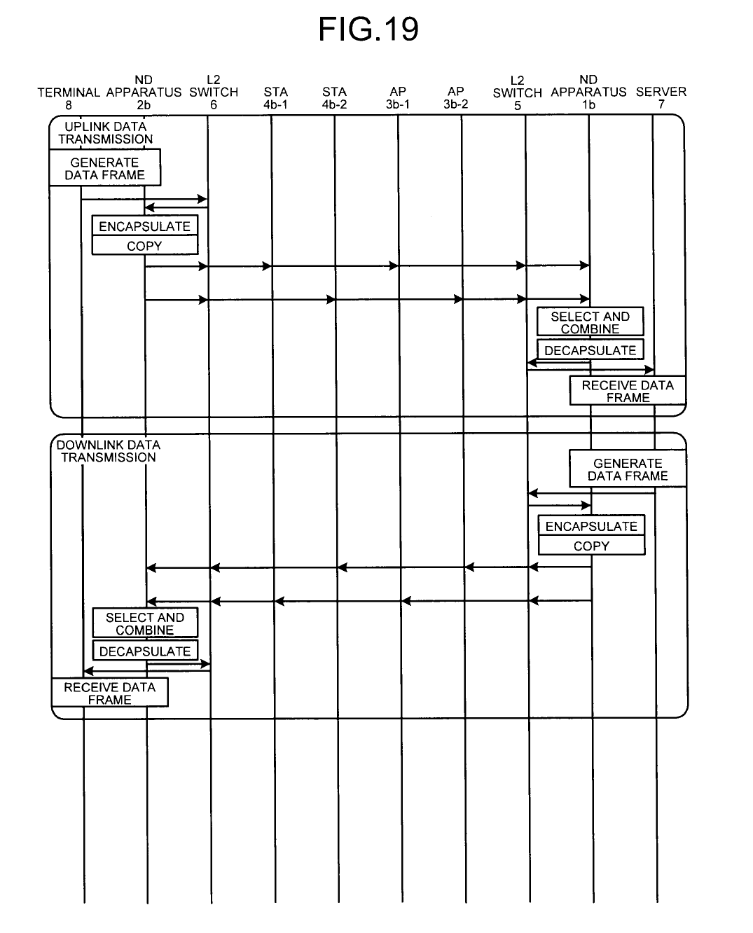

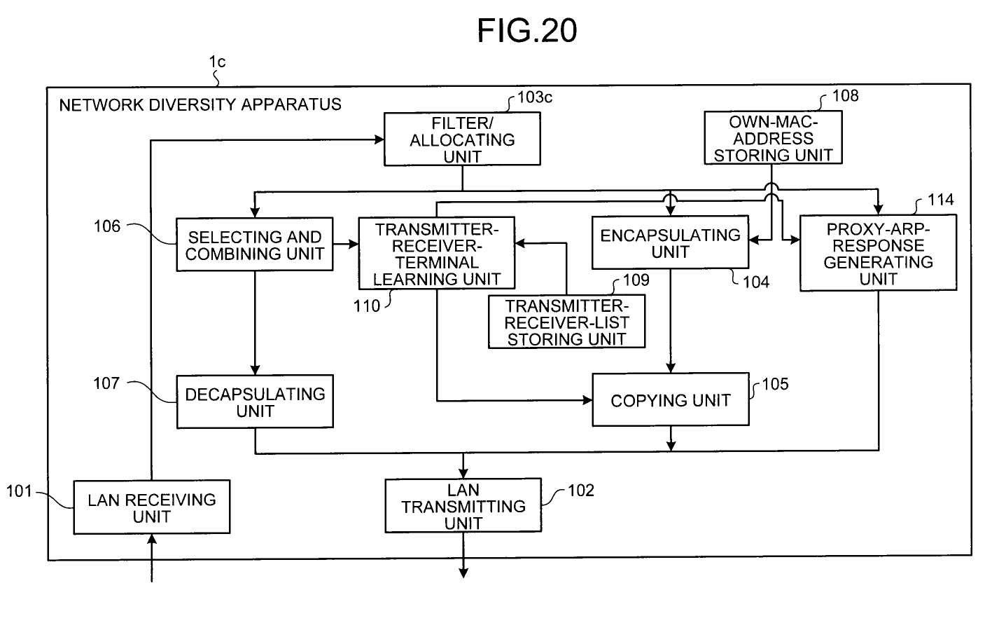

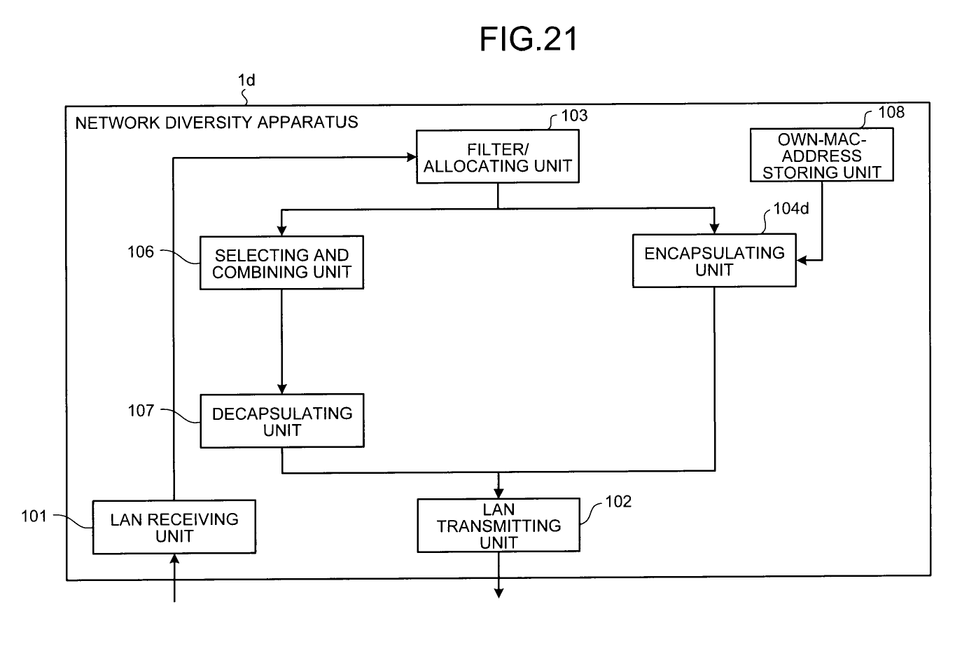

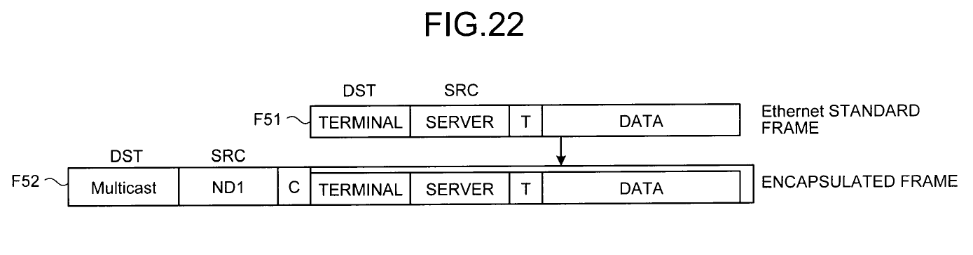

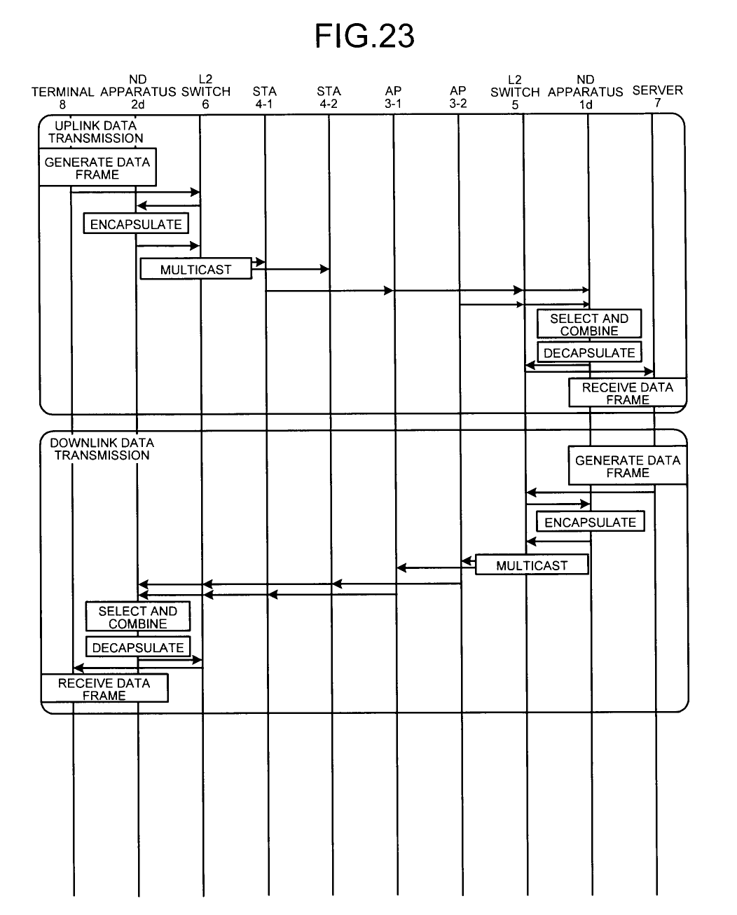

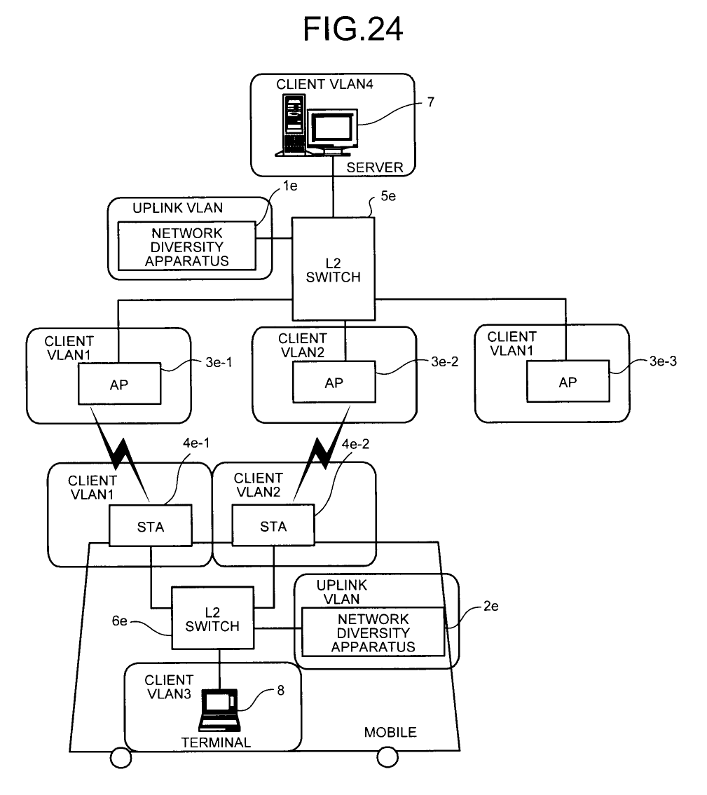

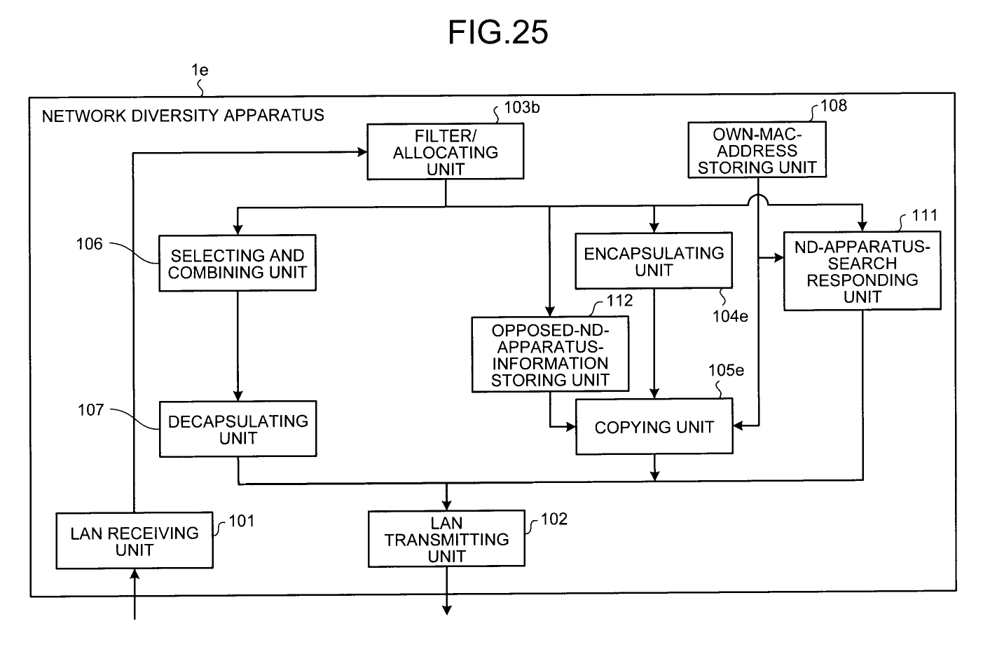

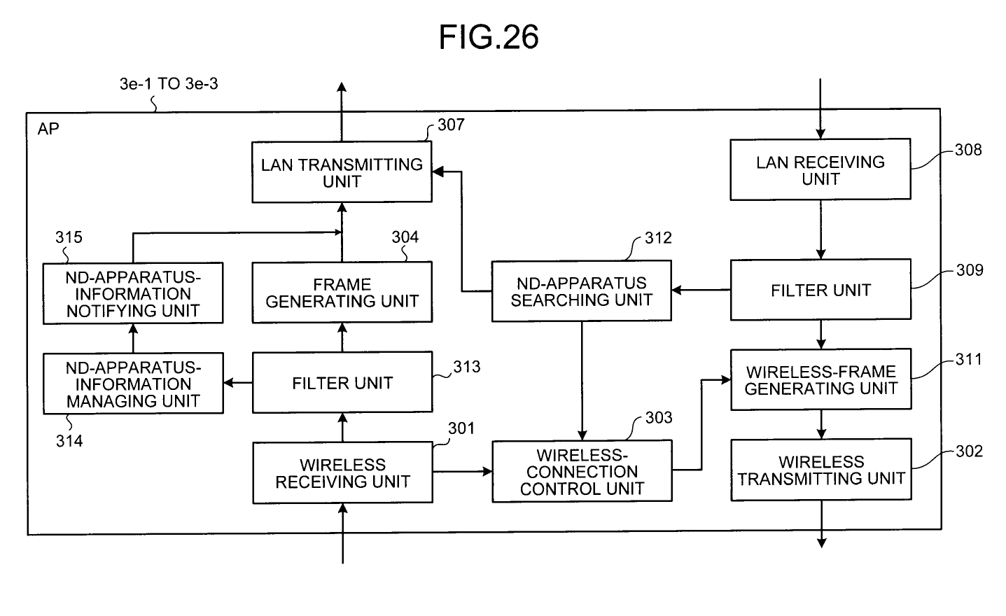

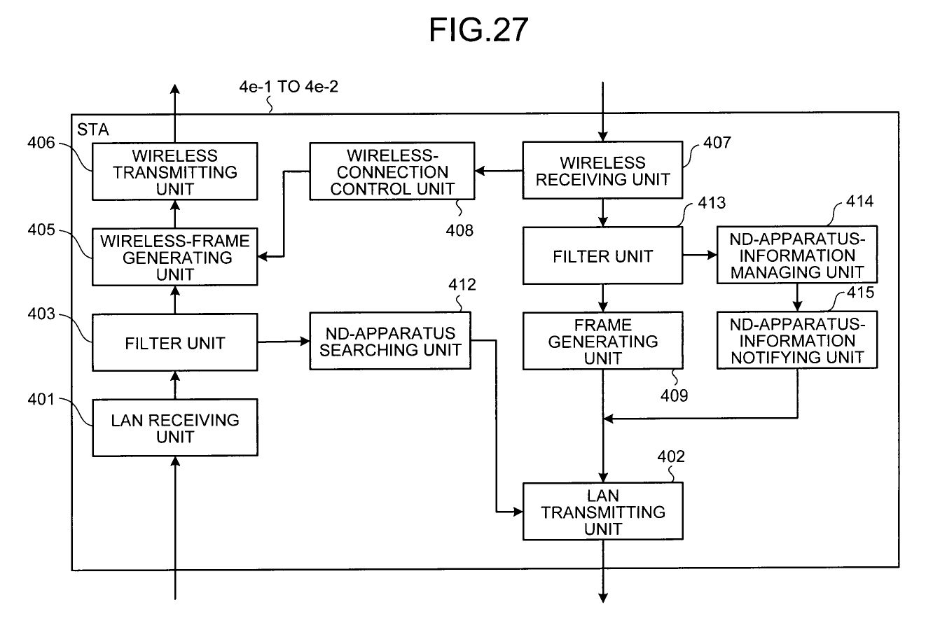

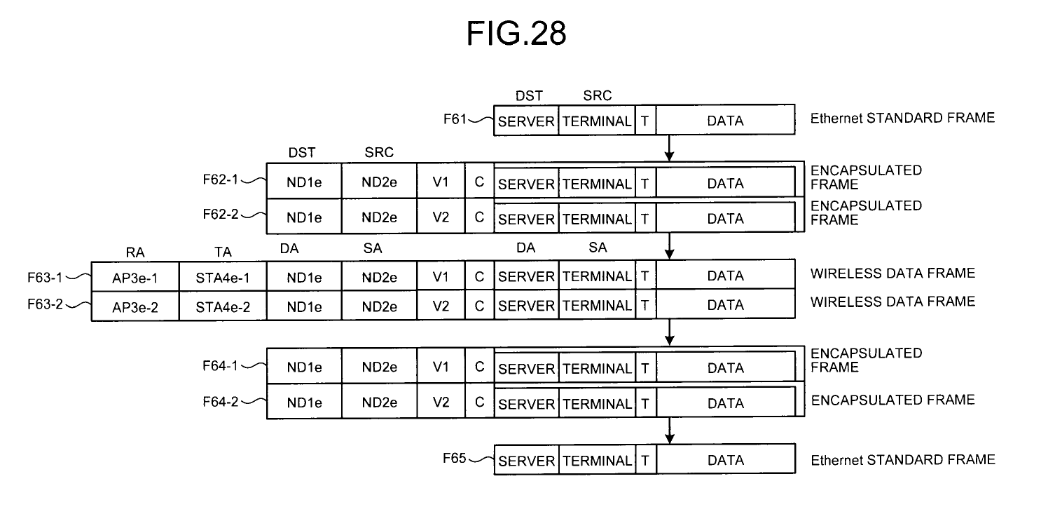

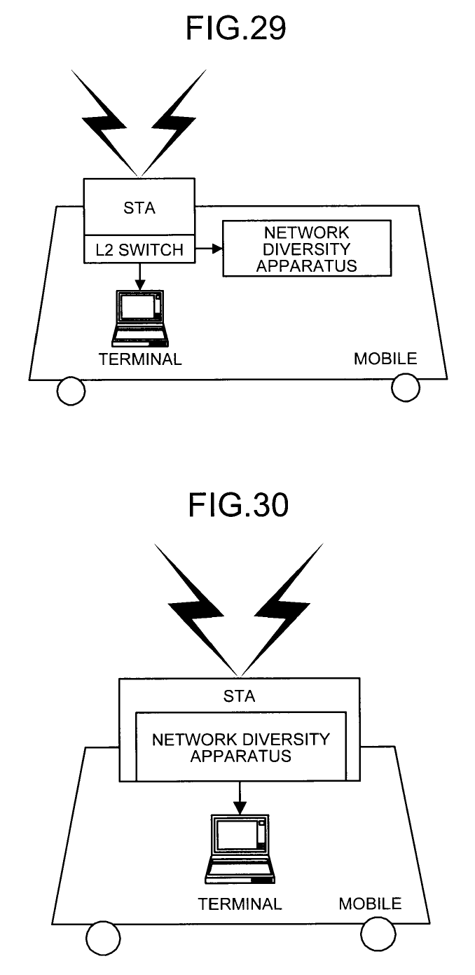

### BRIEF DESCRIPTION OF DRAWINGS

[FIG. 1] FIG. 1 is a diagram of a configuration example of a first embodiment of a communication system according to the present invention.

[FIG. 2-1] FIG. 2-1 is a diagram of a configuration example of an ND apparatus according to the first embodiment.

[FIG. 2-2] FIG. 2-2 is a diagram of a configuration example of an ND apparatus according to the first embodiment.

[FIG. 3] FIG. 3 is a diagram of a configuration example of an AP according to the first embodiment.

[FIG. 4] FIG. 4 is a diagram of a configuration example of an STA according to the first embodiment.

[FIG. 5] FIG. 5 is a diagram of a configuration example of an uplink data frame according to the first embodiment.

[FIG. 6] FIG. 6 is a diagram of a configuration example of a downlink data frame according to the first embodiment.

[FIG. 7] FIG. 7 is a diagram of a sequence example of data frame transmission operation between a terminal apparatus and a server apparatus.

[FIG. 8-1] FIG. 8-1 is a diagram of a configuration example of an ND apparatus according to a second embodiment.

[FIG. 8-2] FIG. 8-2 is a diagram of a configuration example of an ND apparatus according to the second embodiment.

[FIG. 9] FIG. 9 is a diagram of a configuration example of an AP according to the second embodiment.

[FIG. 10] FIG. 10 is a diagram of a configuration example of an STA according to the second embodiment.

[FIG. 11] FIG. 11 is a diagram of a configuration example of a frame used in ND apparatus search.

[FIG. 12-1] FIG. 12-1 is a diagram of a configuration example of an ND apparatus according to a third embodiment.

[FIG. 12-2] FIG. 12-2 is a diagram of a configuration example of an ND apparatus according to the third embodiment.

[FIG. 13] FIG. 13 is a diagram of a configuration example of an AP according to the third embodiment.

[FIG. 14] FIG. 14 is a diagram of a configuration example of an STA according to the third embodiment.

[FIG. 15] FIG. 15 is a diagram of an internal table configuration example of an own-MAC-address storing unit included in the ND apparatus according to the third embodiment.

[FIG. 16] FIG. 16 is a diagram of a search sequence example for a near ND apparatus and a notification sequence example for distant ND apparatus information in a communication system according to the third embodiment.

[FIG. 17] FIG. 17 is a flowchart of an example of processing of the own-MAC-address storing unit included in the ND apparatus according to the third embodiment for determining a value of an own MAC address.

[FIG. 18] FIG. 18 is a diagram of a configuration example of an uplink data frame according to the third embodiment.

[FIG. 19] FIG. 19 is a diagram of a sequence example of data frame transmission operation between a terminal apparatus and a server apparatus.

[FIG. 20] FIG. 20 is a diagram of a configuration example of an ND apparatus according to a fourth embodiment.

[FIG. 21] FIG. 21 is a diagram of a configuration example of an ND apparatus according to a fifth embodiment.

[FIG. 22] FIG. 22 is a diagram of a configuration example of a downlink data frame according to the fifth embodiment.

[FIG. 23] FIG. 23 is a diagram of a configuration example of an uplink data frame according to the fifth embodiment.

[FIG. 24] FIG. 24 is a diagram of a configuration example of a communication system according to a sixth embodiment.

[FIG. 25] FIG. 25 is a diagram of a configuration example of an ND apparatus according to the sixth embodiment.

[FIG. 26] FIG. 26 is a diagram of a configuration example of an AP according to the sixth embodiment.

[FIG. 27] FIG. 27 is a diagram of a configuration example of an STA according to the sixth embodiment.

[FIG. 28] FIG. 28 is a diagram of a configuration example of an uplink data frame according to the sixth embodiment.

[FIG. 29] FIG. 29 is a diagram of a configuration example of the inside of a mobile according to a seventh embodiment.

[FIG. 30] FIG. 30 is a diagram of a configuration example of the inside of a mobile according to the seventh embodiment.

### EXPLANATIONS OF LETTERS OR NUMERALS

1, 2, 1a, 2a, 1b, 2b, 1c, 1d, 2d, 1e, 2e network diversity apparatuses (ND apparatuses)
3-1 to 3-3, 3a-1 to 3a-3, 3e-1 to 3e-3 wireless base stations (APs: Access Points)
4-1, 4-2, 4a-1, 4a-2, 4e-1, 4e-2 wireless terminal stations (STAs: Stations)
5, 6, 5e, 6e layer 2 switches (L2 switches)
7 server apparatus
8 terminal apparatus
101, 102 LAN receiving units
102, 202 LAN transmitting units
103, 103a, 103b, 103c, 203, 203a, 203b filter/allocating units
104, 104d, 104e, 204 encapsulating units
105, 105b, 105e, 205, 205b copying units
106, 206 selecting and combining units
107, 207 decapsulating units
108, 108b, 208, 208b own-MAC-address storing units
109, 209 transmitter-receiver-list storing units
110 transmitter-receiver-terminal learning unit
111, 211 ND-apparatus-search responding units
112, 212 opposed-ND-apparatus-information storing units
113 ND apparatus-terminal learning unit
114 proxy-ARP-response generating unit
181 own-MAC-address storage area
182 search-request-source-AP storage area
183 latest-search-time storage area
301 wireless receiving unit
302 wireless transmitting unit
303 wireless-connection control unit
304 frame generating unit
305 encapsulating unit
306 ND-apparatus-information storing unit
307 LAN transmitting unit
308 LAN receiving unit
309, 313 filter units
310 decapsulating unit
311 wireless-frame generating unit
312, 312b ND-apparatus searching units
314 ND-apparatus-information managing unit
315 ND-apparatus-information notifying unit
316 path-learning-packet generating unit
401 LAN receiving unit
402 LAN transmitting unit
403, 413 filter units
404 decapsulating unit
405 wireless-frame generating unit
406 wireless transmitting unit
407 wireless receiving unit
408 wireless-connection control unit
409 frame generating unit
410 encapsulating unit
411 ND-apparatus-information storing unit
412, 412b ND-apparatus searching units
414 remote-ND-apparatus-information managing unit
415 remote-ND-apparatus-information notifying unit
416 path-learning-packet generating unit

### BEST MODE(S) FOR CARRYING OUT THE INVENTION

Embodiments of a communication system, a communication apparatus, a wireless base station, and a wireless terminal station according to the present invention are explained in detail below with reference to the drawings. The present invention is not limited by the embodiments.

### First Embodiment

FIG. 1 is a diagram of a configuration example of a first embodiment of a communication system according to the present invention. In FIG. 1, reference numeral 1 denotes a network diversity apparatus (ND apparatus) disposed on a stationary network side and connected to a plurality of wireless base stations. Reference numeral 2 denotes a network diversity apparatus (ND apparatus) disposed in a mobile and connected to a plurality of wireless terminal stations. Reference numerals 3-1 to 3-3 denote wireless base stations (APs: Access Points). Reference numerals 4-1 and 4-2 denote wireless terminal stations (STAs: Stations) disposed in the mobile. The STAs perform wireless communication with any one of the APs. Reference numerals 5 and 6 denote a layer 2 switch (L2 switch) on the stationary network side and an L2 switch on the mobile side. Reference numeral 7 denotes a server apparatus connected to the ND apparatus 1 via a wire network or the like. Reference numeral 8 denotes a terminal apparatus disposed in the mobile and connected to the ND apparatus 2 via a local network or the like on the mobile. In this embodiment, an operation example in which the server apparatus 7 and the terminal apparatus 8 perform transmission and reception of data is explained.

In the communication system according to this embodiment, a plurality of paths are established between the ND apparatus 1 on the mobile base station side and the ND apparatus 2 on the mobile side to realize a network diversity function. In the example shown in FIG. 1, a state in which the AP 3-1 and the STA 4-1 are connected by wireless and the AP 3-2 and the STA 4-2 are connected by wireless is shown.

The APs 3-1 to 3-3 are arranged to cover a moving range of the mobile and connected to the ND apparatus 1 via the L2 switch 5. The mobile includes two sets of wireless terminal stations (STAs 4-1 and 4-2). The STAs are connected to the ND apparatus 2 via the L2 switch 6.

FIGS. 2-1 and 2-2 are diagrams of configuration examples of the ND apparatuses 1 and 2. As shown in FIG. 2-1, the ND apparatus 1 includes a LAN receiving unit 101, a LAN transmitting unit 102, a filter/allocating unit 103, an encapsulating unit 104, a copying unit 105, a selecting and combining unit 106, a decapsulating unit 107, an own-MAC-address storing unit 108, a transmitter-receiver-list storing unit 109, and a transmitter-receiver-terminal learning unit 110. As shown in FIG. 2-2, the ND apparatus 2 includes a LAN receiving unit 201, a LAN transmitting unit 202, a filter/allocating unit 203, an encapsulating unit 204, a copying unit 205, a selecting and combining unit 206, a decapsulating unit 207, an own-MAC-address storing unit 208, and a transmitter-receiver-list storing unit 209. The ND apparatus 2 is a sub-set configuration of the ND apparatus 1. Therefore, the components of the ND apparatus 2 have functions same as those of the components of the same names configuring the ND apparatus 1.

The copying unit 105 and the LAN transmitting unit 102 configure a downlink-data-frame copying and transmitting unit described in claims 1, 2, and 12. The selecting and combining unit 106, the decapsulating unit 107, and the LAN transmitting unit 102 configure an uplink-data-frame selecting and transmitting unit described in claims 1, 2, and 12. The transmitter-receiver-terminal learning unit 110 configures a base-station-address storing unit described in claims 5 and 13. The copying unit 205 and the LAN transmitting unit 202 configure an uplink-data-frame copying and transmitting unit described in claims 1 and 2. The selecting and combining unit 206, the decapsulating unit 207, and the LAN transmitting unit 202 configure a downlink-data-frame selecting and transmitting unit described in claims 1 and 2.

FIG. 3 is a diagram of a configuration example of the APs 3-1 to 3-3. The APs have the same configuration. As shown in FIG. 3, each of the APs includes a wireless receiving unit 301, a wireless transmitting unit 302, a wireless-connection control unit 303, a frame generating unit 304, an encapsulating unit 305, an ND-apparatus-information storing unit 306, a LAN transmitting unit 307, a LAN receiving unit 308, a filter unit 309, a decapsulating unit 310, and a wireless-frame generating unit 311.

The wireless-connection control unit 303 configures a wireless-terminal-station-address storing unit described in claims 3 and 16. The encapsulating unit 305 and the LAN transmitting unit 307 configure an uplink-encapsulated-data-frame transmitting unit described in claim 3. The wireless-frame generating unit 311 and the wireless transmitting unit 302 configure a downlink-data-frame transmitting unit described in claims 3 and 17.

FIG. 4 is a diagram of a configuration example of the STAs 4-1 and 4-2. The STAs have the same configuration. As shown in FIG. 4, each of the STAs includes a LAN receiving unit 401, a LAN transmitting unit 402, a filter unit 403, a decapsulating unit 404, a wireless-frame generating unit 405, a wireless transmitting unit 406, a wireless receiving unit 407, a wireless-connection control unit 408, a frame generating unit 409, an encapsulating unit 410, and an ND-apparatus-information storing unit 411.

FIG. 5 is a diagram of a configuration example of an uplink data frame transmitted from the terminal apparatus 8 in the direction of the server apparatus 7 in the communication system. In FIG. 5, reference sign F11 denotes a data frame transmitted from the terminal apparatus 8 to the ND apparatus 2, F12-1 denotes a data frame transmitted from the ND apparatus 2 to the STA 4-1, F12-2 denotes a data frame transmitted from the ND apparatus 2 to the STA 4-2, F13-1 denotes a data frame transmitted from the STA 4-1 to the AP 3-1, F13-2 denotes a data frame transmitted from the STA 4-2 to the AP 3-2, F14-1 denotes a data frame transmitted from the AP 3-1 to the ND apparatus 1, F14-2 denotes a data frame transmitted from the AP 3-2 to the ND apparatus 1, and F15 denotes a data frame transmitted from the ND apparatus 1 to the server apparatus 7.

In FIG. 5, reference sign DST denotes a destination address, SRC denotes a source address, RA denotes a receiver address, TA denotes a transmitter address, DA denotes a destination address, SA denotes a source address, T denotes a data type identifier, and C denotes an encapsulated data identifier. These are the same in a data frame configuration explained later.

FIG. 6 is a diagram of a configuration example of a downlink data frame transmitted from the server apparatus 7 in the direction of the terminal apparatus 8 in the communication system. In FIG. 6, reference sign F21 denotes a data frame transmitted from the server apparatus 7 to the ND apparatus 1, F22-1 denotes a data frame transmitted from the ND apparatus 1 to the AP 3-1, F22-2 denotes a data frame transmitted from the ND apparatus 1 to the AP 3-2, F23-1 denotes a data frame transmitted from the AP 3-1 to the STA 4-1, F23-2 denotes a data frame transmitted from the AP 3-2 to the STA 4-2, F24-1 denotes a data frame transmitted from the STA 4-1 to the ND apparatus 2, F24-2 denotes a data frame transmitted from the STA 4-2 to the ND apparatus 2, and F25 denotes a data frame transmitted from the ND apparatus 2 to the terminal apparatus 8.

FIG. 7 is a diagram of a sequence example in which an uplink data frame is transmitted from the terminal apparatus 8 in the direction of the server apparatus 7 in the communication system and a sequence example in which a downlink data frame is transmitted from the server apparatus 7 in the direction of the terminal apparatus 8.

Transmission operation for traffic in an uplink direction flowing from the terminal apparatus 8 to the server apparatus 7 and transmission operation for traffic in a downlink direction flowing in the opposite direction are explained with reference to FIGS. 1 to 7.

First, the transmission operation for the traffic in the uplink direction is explained. The ND apparatus 1 recognizes the presence of the APs 3-1 to 3-3 and stores information concerning the APs (address information of the APs, etc.) in the transmitter-receiver-list storing unit 109 (see FIG. 2-1). On the other hand, the ND apparatus 2 recognizes the presence of the STAs 4-1 and 4-2 in the mobile and stores information concerning the STAs (address information of the STAs, etc.) in the transmitter-receiver-list storing unit 209 (see FIG. 2-2). The APs 3-1 to 3-3 recognize the presence of the ND apparatus 1 and store ND apparatus information (address information of the ND apparatus, etc.) in the ND-apparatus-information storing unit 306.

In the ND apparatus 2 having the configuration shown in FIG. 2-2, the filter/allocating unit 203 allocates a data frame received from the terminal apparatus 8 among data frames received by the LAN receiving unit 201 to the encapsulating unit 204. The filter/allocating unit 203 performs this allocating operation when an un-encapsulated data frame is received, i.e., when the data frame F11 (see FIG. 5) not attached with an encapsulated data identifier is received. When an encapsulated data frame is received, the filter/allocating unit 203 passes the received data frame to the selecting and combining unit 206.

When a data frame (an un-encapsulated data frame) is received from the filter/allocating unit 203, the encapsulating unit 204 encapsulates the data frame. The encapsulating unit 204 sets an MAC address of the own apparatus (the ND apparatus 2), which is information stored by the own-MAC-address storing unit 208, as a source address (equivalent to Step S11 in FIG. 7).

The copying unit 205 copies an encapsulated frame, which is the data frame encapsulated by the encapsulating unit 204, and sets destinations of the encapsulated data frame in the STA 4-1 and the STA 4-2 using information (MAC addresses of the STAs) stored by the transmitter-receiver-list storing unit 209 (equivalent to Step S12 in FIG. 7). Consequently, the copying unit 205 generates the data frames F12-1 and F12-2 as the encapsulated data frames shown in FIG. 5. The generated data frames F12-1 and F12-2 are passed to the LAN transmitting unit 202. The LAN transmitting unit 202 transmits the received data frames F12-1 and F12-2.

In the STA 4-1 and the STA 4-2 having the configuration shown in FIG. 4, the LAN receiving unit 401 receives data frames. The filter unit 403 extracts only an encapsulated data frame out of the data frames received by the LAN receiving unit 401 and passes the encapsulated data frame to the decapsulating unit 404. The decapsulating unit 404 removes an encapsulated header section (a header section given by the encapsulating unit 204 of the ND apparatus 2) from the received encapsulated data frame and passes the encapsulated data frame to the wireless-frame generating unit 405. The wireless-frame generating unit 405 acquires connection AP information from the wireless-connection control unit 408 and generates a wireless data frame (e.g., a frame of the IEEE 802.11 standard) using this connection AP information. Specifically, the wireless-frame generating unit 405 generates a wireless data frame with a destination set to an AP under connection (equivalent to Step S13 in FIG. 7). The data frame F13-1 shown in FIG. 5 is the wireless data frame generated by the STA 4-1 and the data frame F13-2 shown in FIG. 5 is the wireless data frame generated by the STA 4-2. The wireless transmitting unit 406 transmits the wireless data frames generated by the operation explained above to the AP under connection.

In the APs 3-1 to 3-3 having the configuration shown in FIG. 3, when a wireless data frame is received from an STA under connection, the wireless receiving unit 301 passes the wireless data frame to the frame generating unit 304.

Address information of the STA as a transmitter and address information of the terminal apparatus 8 as a traffic source are passed from the wireless receiving unit 301 to the wireless-connection control unit 303. The wireless-connection control unit 303 stores the received address information of the STA and address information of the terminal apparatus 8 in association with each other and prepares for transmission operation for traffic in the opposite direction (downlink traffic).

The frame generating unit 304 removes a header section of the received wireless data frame and passes the wireless data frame to the encapsulating unit 305. The encapsulating unit 305 encapsulates the data frame received from the frame generating unit 304, acquires information (MAC address information of the ND apparatus 1) stored by the ND-apparatus-information storing unit 306, and sets the information as a destination address of the encapsulated data frame (equivalent to Step S14 in FIG. 7). The data frame F14-1 shown in FIG. 5 is the encapsulated data frame generated by the encapsulating unit 305 of the AP 3-1 and the data frame F14-2 shown in FIG. 5 is the encapsulated data frame generated by the encapsulating unit 305 of the AP 3-2. The LAN transmitting unit 307 transmits the encapsulated data frames generated by the operation explained above to the ND apparatus 1.

In the ND apparatus 1 having the configuration shown in FIG. 2-1, the filter/allocating unit 103 allocates an encapsulated data frame received from the AP 3-1 or the AP 3-2 among data frames received by the LAN receiving unit 101 to the selecting and combining unit 106. The filter/allocating unit 103 performs this allocating operation when an encapsulated data frame is received, i.e., when the data frame F14-1 or F14-2 (see FIG. 5) attached with an encapsulated data identifier is received. When an un-encapsulated data frame is received, the filter/allocating unit 103 passes the received data frame to the encapsulating unit 104.

Address information of the AP as a transmitter and address information of the terminal apparatus 8 as a traffic source are passed from the selecting and combining unit 106 to the transmitter-receiver-terminal learning unit 110. The transmitter-receiver-terminal learning unit 110 stores the received address information of the AP and address information of the terminal apparatus 8 in association with each other and prepares for transmitting operation for traffic in the opposite direction (downlink traffic). An AP that communicates with an STA connected to the terminal apparatus 8 according to the elapse of time (according to the movement of the mobile in which the terminal apparatus 8 is disposed). Therefore, at this point, an AP through which data frame is exchanged with the terminal apparatus 8 is stored.

When encapsulated data frames including the same data (hereinafter simply referred to as same frames) are received from the AP 3-1 and the AP 3-2, the selecting and combining unit 106 selects one of the same frames and passes the frame to the decapsulating unit 107 (equivalent to Step S15 in FIG. 7). The decapsulating unit 107 removes an encapsulated header section (a header section given by the encapsulating unit 305 of the AP 3-1 or the AP 3-2) from the received encapsulated data frame and passes the data frame to the LAN transmitting unit 102 (equivalent to Step S16 in FIG. 7). The data frame F15 shown in FIG. 5 is a data frame passed from the decapsulating unit 107 to the LAN transmitting unit 102. The LAN transmitting unit 102 transmits the data frame F15 generated by the operation explained above to the server apparatus 7.

Transmitting operation for traffic in a downlink direction is explained. The STAs 4-1 and 4-2 recognize the presence of the ND apparatus 2 and store ND apparatus information in the ND-apparatus-information storing unit 411.

In the ND apparatus 1 having the configuration shown in FIG. 2-1, the filter/allocating unit 103 allocates a data frame received from the server apparatus 7 among data frames received by the LAN receiving unit 101 to the encapsulating unit 104. The filter/allocating unit 103 performs this allocating operation when an un-encapsulated data frame is received, i.e., when the data frame F21 (see FIG. 6) not attached with an encapsulated data identifier is received. When an encapsulated data frame is received, the filter/allocating unit 103 passes the received data frame to the selecting and combining unit 106.

When a data frame (an un-encapsulated data frame) is received from the filter/allocating unit 103, the encapsulating unit 104 encapsulates the data frame. The encapsulating unit 104 sets an MAC address of an own apparatus (the ND apparatus 1), which is information stored by the own-MAC-address storing unit 108, as a source address (equivalent to Step S21 in FIG. 7).

The copying unit copies the encapsulated data frames, which are the data frames encapsulated by the encapsulating unit 104, and sets destinations of the encapsulated data frames to the AP 3-1 and the AP 3-2 (equivalent to Step S22 in FIG. 7). The copying unit 105 acquires address information of the AP 3-1 and address information of the AP 3-2 set as the destinations from the transmitter-receiver-terminal learning unit 110 using address information of the terminal apparatus 8, which is a destination (DST) of the data frame (the downlink data frame F21 shown in FIG. 6) transmitted from the server apparatus 7, as a key. Consequently, the copying unit 105 generates the data frames F22-1 and F22-2 as the encapsulated data frames shown in FIG. 6. The generated data frames F12-1 and F12-2 are passed to the LAN transmitting unit 102. The LAN transmitting unit 102 transmits the received data frames F22-1 and F22-2.

In the APs 3-1 to 3-3 having the configuration shown in FIG. 3, the LAN receiving unit 308 receives data frames. The filter unit 309 extracts only an encapsulated data frame out of the data frames received by the LAN receiving unit 308 and passes the encapsulated data frame to the decapsulating unit 310. The decapsulating unit 310 removes an encapsulated header section from the received encapsulated data frame and passes the data frame to the wireless-frame generating unit 311. The wireless-frame generating unit 311 acquires address information of the STA 4-1 and address information of the STA 4-2 using the address information of the terminal apparatus 8 as a key and generates a wireless data frame using the acquired information (equivalent to Step S23 in FIG. 7). Specifically, the wireless-frame generating unit 311 generates a wireless data frame with a destination set to an STA under connection. The data frame F23-1 shown in FIG. 6 is a wireless data frame generated by the AP 3-1 and the data frame F23-2 shown in FIG. 6 is a wireless data frame generated by the AP 3-2. The wireless transmitting unit 302 transmits the wireless data frames generated by the operation explained above to the STA under connection.

In the STA 4-1 and the STA 4-2 shown in FIG. 4, when a wireless data frame is received from an AP under connection, the wireless receiving unit 407 passes the wireless data frame to the frame generating unit 409.

The frame generating unit 409 removes a header section of the received wireless data frame and passes the wireless data frame to the encapsulating unit 410. The encapsulating unit 410 encapsulates the data frame received from the frame generating unit 409, acquires information (MAC address information of the ND apparatus 2) stored by the ND-apparatus-information storing unit 411, and sets the information as a destination address of an encapsulated data frame (equivalent to Step S24 in FIG. 7). The data frame F24-1 shown in FIG. 6 is an encapsulated data frame generated by the encapsulating unit 410 of the STA 4-1 and the data frame F24-2 shown in FIG. 6 is an encapsulated data frame generated by the encapsulating unit 410 of the STA 4-2. The LAN transmitting unit 402 transmits the encapsulated data frames generated in the operation explained above to the ND apparatus 2.

In the ND apparatus 2 having the configuration shown in FIG. 2-2, the filter/allocating unit 203 allocates an encapsulated data frame received from the STA 4-1 or the STA 4-2 among data frames received by the LAN receiving unit 201 to the selecting and combining unit 206. The filter/allocating unit 203 performs this allocating operation when an encapsulated data frame is received, i.e., when the data frame F24-1 or F24-2 (see FIG. 6) attached with an encapsulated data identifier is received. When an un-encapsulated data frame is received, the filter/allocating unit 203 passes the received data frame to the encapsulating unit 204.

When the same frames are received from the STA 4-1 and the STA 4-2, the selecting and combining unit 206 selects one of the received same frames and passes the frame to the decapsulating unit 207 (equivalent to Step S25 in FIG. 7). The decapsulating unit 207 removes an encapsulated header section from the received encapsulated data frame and passes the data frame to the LAN transmitting unit 202 (equivalent to Step S26 in FIG. 7). The data frame F25 shown in FIG. 6 is a data frame passed from the decapsulating unit 207 to the LAN transmitting unit 202. The LAN transmitting unit 202 transmits the data frame F25 generated by the operation explained above to the terminal apparatus 8.

In this embodiment, the two sets of APs and STAs simultaneously perform wireless connection and transmit the two same frames in parallel. However, the present invention is not limited to this. Three or more sets of APs and STAs can simultaneously perform wireless connection and transmit a number of same frames corresponding to the number of wireless connections in parallel.

As explained above, in this embodiment, in the transmitting operation for an uplink data frame, a data frame is copied by the ND apparatus on the mobile side and, on the other hand, in the transmitting operation for a downlink data frame, a data frame is copied by the ND apparatus on the stationary network side, the same data frames (data frames including the same data) are transmitted to the opposed ND apparatuses via a plurality of wireless communication paths, and the ND apparatus that receives a plurality of the same data frames select one of the data frames and delivers the data frame to a destination. Consequently, it is possible to prevent data short break if at least one wireless communication path is secured and to realize a communication system that does not give discomfort to a user.

Because the AP and the STA transmit only an encapsulated data frame among frames received by the LAN receiving units, an intra-system wire communication section can be realized by only the standard L2 switching operation of the L2 switch by always using an encapsulated frame for communication between the ND apparatus and the AP and between the ND apparatus and the STA. Therefore, it is possible to realize the communication system according to the present invention by connecting the ND apparatus and the AP and the STA using an existing network.

Further, in a generation source of traffic and an apparatus that performs traffic termination, communication can be realized by transmission and reception of a standard Ethernet (registered trademark) frame. Therefore, it is possible to realize seamless communication even when a commercially available apparatus is connected to the communication system according to the present invention.

### Second Embodiment

A communication system according to a second embodiment is explained. In the first embodiment, the AP and the STA recognize the presence of the near ND apparatus and uniquely designate a destination in encapsulation. An embodiment in which an AP and an STA search for a near AD apparatus with the same system configuration (see FIG. 1) as the first embodiment is explained below.

FIGS. 8-1 and 8-2 are diagrams of a configuration example of an ND apparatus 1a disposed on a wireless base station side and a configuration example of an ND apparatus 2a disposed in a mobile in the communication system according to the second embodiment.

As shown in FIG. 8-1, the ND apparatus 1a includes a filter/allocating unit 103a instead of the filter/allocating unit 103 of the ND apparatus 1 (see FIG. 2-1) according to the first embodiment. Further, an ND-apparatus-search responding unit 111 is added. As shown in FIG. 8-2, the ND apparatus 2a includes a filter/allocating unit 203a instead of the filter/allocating unit 203 of the ND apparatus 2 (see FIG. 2-2) according to the first embodiment. Further, an ND-apparatus-search responding unit 211 is added. Other components are the same as those of the ND apparatus 1 or 2 according to the first embodiment. Therefore, the components are denoted by the same reference numerals and signs and explanation of the components is omitted.

FIG. 9 is a diagram of a configuration example of APs (an AP 3a-1 to an AP 3a-3; the APs according to this embodiment are hereinafter collectively referred to as AP 3a) according to the second embodiment. The AP 3a-1 to the AP 3a-3 include an ND-apparatus searching unit 312 instead of the ND-apparatus-information storing unit 306 included in the APs 3-1 to 3-3 (see FIG. 3) according to the first embodiment. Other components are the same as those of the APs 3-1 to 3-3 according to the first embodiment. Therefore, the components are denoted by the same reference numerals and signs and explanation of the components is omitted.

The ND-apparatus searching unit 312 configures a first network-diversity-apparatus searching unit described in claim 4 and a network-diversity-apparatus searching unit described in claim 18. The wireless-connection control unit 303 configures a wireless-terminal-station-address storing unit described in claims 4 and 18. The encapsulating unit 305 and the LAN transmitting unit 307 configure an uplink-encapsulated-data-frame transmitting unit described in claims 4 and 18. The wireless-frame generating unit 311 and the wireless transmitting unit 302 configure a downlink-encapsulated-data-frame transmitting unit described in claims 4 and 18.

FIG. 10 is a diagram of a configuration example of STAs (an STA 4a-1 and an STA 4a-2; the STAs according to this embodiment is hereinafter collectively referred to as STA 4a) according to the second embodiment. The STA 4a-1 and the STA 4a-2 include an ND-apparatus searching unit 412 instead of the ND-apparatus-information storing unit 411 included in the STAs 4-1 and 4-2 (see FIG. 4) according to the first embodiment. Other components are the same as those of the STAs 4-1 and 4-2 according to the first embodiment. Therefore, the components are denoted by the same reference numerals and signs and explanation of the components is omitted.

The ND-apparatus searching unit 412 configures a second network-diversity-apparatus searching unit described in claim 4 and a network-diversity-apparatus searching unit described in claim 19. The encapsulating unit 410 and the LAN transmitting unit 402 configure a downlink-encapsulated-data-frame transmitting unit described in claims 4 and 19.

FIG. 11 is a diagram of a configuration example of a frame used in ND apparatus search. Reference sign F31 in FIG. 11 denotes a broadcast frame of an ND apparatus search request generated by the ND-apparatus searching unit 312 of the AP 3a and transmitted from the LAN transmitting unit 307. A broadcast frame of an ND apparatus search request generated by the ND-apparatus searching unit 412 of the STA 4a has the same configuration. An address of the STA 4a-1 or 4a-2 is set as an SRC (a source address). Reference sign F32 denotes a unicast frame of an ND apparatus search response generated by the ND-apparatus-search responding unit 111 of the ND apparatus 1a and transmitted from the LAN transmitting unit 102. A unicast frame of an ND apparatus search response generated by the ND-apparatus-search responding unit 211 of the ND apparatus 2a has the same configuration. An address of the ND apparatus 2a is set as an SRC (a source address). In FIG. 11, reference sign ‘D’ denotes an ND apparatus search request identifier.

A procedure of the AP 3a (the AP 3a-1 to the AP 3a-3) and the STA 4a (the STA 4a-1 and the STA 4a-2) for searching for an ND apparatus is explained with reference to FIGS. 8-1 to FIG. 11.

First, a procedure of the AP 3a for searching for an ND apparatus is explained. When the AP 3a is started, the AP 3a generates the ND apparatus search request frame F31 in the ND-apparatus searching unit 312 and passes the frame to the LAN transmitting unit 307. The LAN transmitting unit 307 broadcast-transmits the received frame.

When the ND apparatus 1a having the configuration shown in FIG. 8-1 receives the ND apparatus search request frame F31 broadcast-transmitted from the AP 3a, the filter/allocating unit 103a allocates the ND apparatus search request frame received from the AP 3a among data frames received by the LAN receiving unit 101 to the ND-apparatus-search responding unit 111. The filter/allocating unit 103a performs this allocating operation when the ND apparatus search request frame is received, i.e., when the frame F31 (see FIG. 11) attached with an ND apparatus search request identifier is received. When a frame other than the ND apparatus search request frame is received, the filter/allocating unit 103a passes the received frame to the encapsulating unit 104 or the selecting and combining unit 106.

The ND-apparatus-search responding unit 111 passes information concerning the AP 3a, which is a transmission source of the received ND apparatus search request frame, to the transmitter-receiver-list storing unit 109, generates the ND apparatus search response frame F32 (see FIG. 11) using information stored by the own-MAC-address storing unit 108, and passes the generated ND apparatus search response frame to the LAN transmitting unit 102. A DST (a destination address) of the ND apparatus search response frame is an address of the AP 3a at a transmission source of the ND apparatus search response frame corresponding thereto. The LAN transmitting unit 102 transmits the received ND apparatus search response frame. The transmitter-receiver-list storing unit 109 stores the information concerning the AP 3a at the transmission source of the ND apparatus search request until the ND apparatus 1a finishes operation. In the traffic transmitting operation in the downlink direction explained in the first embodiment, the transmitter-receiver-list storing unit 109 provides the transmitter-receiver-terminal learning unit 110 with the information.

In the AP 3a, the LAN receiving unit 308 receives frames. A filter unit 309a extracts an ND apparatus search response frame out of the frames received by the LAN receiving unit 308 and passes the ND apparatus search response frame to the ND-apparatus searching unit 312. The ND-apparatus searching unit 312 stores information concerning the ND apparatus 1a at the transmission source of the ND apparatus search response until the AP 3a finishes operation. In the traffic transmitting operation in the uplink direction explained in the first embodiment, the ND-apparatus searching unit 312 provides the encapsulating unit 305 with the information in the same manner as the ND-apparatus-information storing unit 306 included in the AP according to the first embodiment.

A procedure of the STA 4a for searching for an ND apparatus is explained. When the STA 4a is started, the ND-apparatus searching unit 412 of the STA 4a performs operation same as that of the ND-apparatus searching unit 312 of the AP 3a explained above and generates the ND apparatus search request frame F31. The generated ND apparatus search request frame F31 is passed to the LAN transmitting unit 402 and broadcast-transmitted.

When the NM apparatus search request frame F31 broadcast-transmitted from the STA 4a is received, the ND apparatus 2a shown in FIG. 8-2 performs the same operation as the ND apparatus 1a, stores information concerning the STA 4a in the transmitter-receiver-list storing unit 209, and provides the copying unit 2-5 with the information in the traffic transmitting operation in the uplink direction explained in the first embodiment. The ND-apparatus-search responding unit 211 generates the ND apparatus search response frame F32 using the information stored by the own-MAC-address storing unit 208. The generated ND apparatus search response frame F32 is transmitted to the STA 4a at a transmission source of the ND apparatus search response frame corresponding thereto via the LAN transmitting unit 202.

The ND-apparatus searching unit 412 of the STA 4a stores information concerning the ND apparatus 2a in the same manner as the ND-apparatus searching unit 312 of the AP 3a and, in the traffic transmitting operation in the downlink direction explained in the first embodiment, provides the encapsulating unit 410 with the information in the same manner as the ND-apparatus-information storing unit 411 included in the STA according to the first embodiment.

The traffic transmitting operation in the uplink direction and the traffic transmitting operation in the downlink direction are the same as those in the first embodiment explained above.

In this way, in this embodiment, the AP and the STA search for a near ND apparatus and stores information concerning the ND apparatus to be connected. The ND apparatus stores information concerning the AP or the STA that performs ND apparatus search. Consequently, in addition to the effect of the first embodiment, it is possible to realize the communication system according to the present invention without performing prior setting of stored information simply by connecting the ND apparatus and the AP and the STA to the existing network.

### Third Embodiment

A communication system according to a third embodiment is explained. In the first and second embodiments, the encapsulated frame is transmitted and received between the ND apparatus and the AP and between the ND apparatus and the STA. An embodiment in which ND apparatuses including a wireless section transmit and receive an encapsulated frame with the system configuration (see FIG. 1) same as the first embodiment is explained below.

FIGS. 12-1 and 12-2 are diagrams of a configuration example of an ND apparatus 1b disposed on a wireless base station side and a configuration example of an ND apparatus 2b disposed in a mobile in the communication system according to the third embodiment.

As shown in FIG. 12-1, the ND apparatus 1b includes a filter/allocating unit 103b, a copying unit 105b, an own-MAC-address storing unit 108b, an opposed-ND-apparatus-information storing unit 112, and an ND-apparatus-terminal learning unit 113 instead of the filter/allocating unit 103a, the copying unit 105, the own-MAC-address storing unit 108, the transmitter-receiver-list storing unit 109, and the transmitter-receiver-terminal learning unit 110 of the ND apparatus 1a (see FIG. 8-1) according to the second embodiment. Other components are the same as those of the ND apparatus 1a according to the second embodiment. Therefore, the components are denoted by the same reference numerals and signs and explanation of the components is omitted.

The copying unit 105b and the LAN transmitting unit 102 configure a downlink-data-frame copying and transmitting unit described in claim 7. The selecting and combining unit 106, the decapsulating unit 107, and the LAN transmitting unit 102 configure an uplink-data-frame selecting and transmitting unit described in claim 7.

As shown in FIG. 12-2, the ND apparatus 2b includes a filter/allocating unit 203b, a copying unit 205b, an own-MAC-address storing unit 208b, and an opposed-ND-apparatus-information storing unit 212 instead of the filter/allocating unit 203a, the copying unit 205, the own-MAC-address storing unit 208, and the transmitter-receiver-list storing unit 209 of the ND apparatus 2a (see FIG. 8-2) according to the second embodiment. Other components are the same as those of the ND apparatus 2a according to the second embodiment. Therefore, the components are denoted by the same reference numerals and signs and explanation of the components is omitted.

The copying unit 205b and the LAN transmitting unit 202 configure an uplink-data-frame copying and transmitting unit described in claim 7. The selecting and combining unit 206, the decapsulating unit 207, and the LAN transmitting unit 202 configure a downlink-data-frame selecting and transmitting unit described in claim 7.

FIG. 13 is a diagram of a configuration example of APs (an AP 3b-1 to an AP 3b-3; the APs according to this embodiment are hereinafter collectively referred to as AP 3b) according to the third embodiment. The APs 3b-1 to 3b-3 include the wireless receiving unit 301, the wireless transmitting unit 302, the wireless-connection control unit 303, the frame generating unit 304, the LAN transmitting unit 307, the LAN receiving unit 308, the filter unit 309, the wireless-frame generating unit 311, an ND-apparatus searching unit 312b, a filter unit 313, an ND-apparatus-information managing unit 314, an ND-apparatus-information notifying unit 315, and a path-learning-packet generating unit 316. The wireless receiving unit 301, the wireless transmitting unit 302, the wireless-connection control unit 303, the frame generating unit 304, the LAN transmitting unit 307, the LAN receiving unit 308, the filter unit 309, and the wireless-frame generating unit 311 perform operation same as the operation performed by the components denoted by the same reference numerals and signs of the APs 3-1 to 3-3 according to the first embodiment. Therefore, explanation of the components is omitted.

The ND-apparatus searching unit 312b configures a first network-diversity-apparatus searching unit and a first address-information exchanging unit described in claim 9. The ND-apparatus-information notifying unit 315 configures a first address-information notifying unit described in claims 9 and 10.

FIG. 14 is a diagram of a configuration example of STAs (an STA 4b-1 and an STA 4b-2; the STAs according to this embodiment are hereinafter collectively referred to as STA 4b) according to the third embodiment. The STAs 4b-1 and 4b-2 includes the LAN receiving unit 401, the LAN transmitting unit 402, the filter unit 403, the wireless-frame generating unit 405, the wireless transmitting unit 406, the wireless receiving unit 407, the wireless-connection control unit 408, the frame generating unit 409, an ND-apparatus searching unit 412b, a filter unit 413, a remote-ND-apparatus-information managing unit 414, a remote-ND-apparatus-information notifying unit 415, and a path-learning-packet generating unit 416. The LAN receiving unit 401, the LAN transmitting unit 402, the filter unit 403, the wireless-frame generating unit 405, the wireless transmitting unit 406, the wireless receiving unit 407, the wireless-connection control unit 408, and the frame generating unit 409 perform operation same as the operation performed by the components denoted by the same reference numerals and signs of the STAs 4-1 and 4-2 according to the first embodiment. Therefore, explanation of the components is omitted.

The ND-apparatus searching unit 412b configures a second network-diversity-apparatus searching unit and a second address-information exchanging unit described in claims 9 and 10. The ND-apparatus-information notifying unit 415 configures a second address-information notifying unit described in claims 9 and 10.

FIG. 15 is a diagram of an internal table configuration example of the own-MAC-address storing unit 108b included in the ND apparatus 1b. The own-MAC-address storing unit 108b includes two sets of an own-MAC-address storage area 181, a search-request-source-AP storage area 182, and a latest-search-time storage area 183. In an internal table configuration of the MAC-address storing unit 208b included in the ND apparatus 2b, the search-request-source-AP storage area shown in FIG. 15 is replaced with a search-request-source-STA storage area.

FIG. 16 is a diagram of a sequence example for searching for a near ND apparatus and a sequence example for notifying remote ND apparatus information in the communication system according to the third embodiment.

FIG. 17 is a flowchart of an example of processing for determining a value of an own MAC address used for ND apparatus search response by the own-MAC-address storing unit 108b.

FIG. 18 is a diagram of a configuration example of an uplink data frame transmitted from the terminal apparatus 8 in the direction of the server apparatus 7 in the communication system according to the third embodiment. In FIG. 18, reference sign F41 denotes a data frame transmitted from the terminal apparatus 8 to the ND apparatus 2b, F42-1 denotes a data frame transmitted from the ND apparatus 2b to the STA 4b-1, F42-2 denotes a data frame transmitted from the ND apparatus 2b to the STA 4b-2, F43-1 denotes a data frame transmitted from the STA 4b-1 to the AP 3b-1, F43-2 denotes a data frame transmitted from the STA 4b-2 to the AP 3b-2, F44-1 denotes a data frame transmitted from the AP 3b-1 to the ND apparatus 1b, F44-2 denotes a data frame transmitted from the AP 3b-2 to the ND apparatus 1b, and F45 denotes a data frame transmitted from the ND apparatus 1b to the server apparatus 7b.

FIG. 19 is a diagram of a sequence example in which an uplink data frame is transmitted from the terminal apparatus 8 in the direction of the server apparatus 7 and a sequence example in which a downlink data frame is transmitted from the server apparatus 7 in the direction of the terminal apparatus 8 in the communication system according to the third embodiment.

A procedure of the AP 3b (the AP 3b-1 to the AP 3b-3) and the STA 4b (the STAs 4b-1 and 4b-2) for searching for an ND apparatus is explained with reference to FIG. 16. Each of the ND apparatus 1b and the ND apparatus 2b has a plurality of (two in this embodiment) MAC addresses and stores the MAC addresses in the own-MAC-address storing area (108b, 208b).

First, a procedure of the AP 3b for searching for an ND apparatus is explained. The AP 3b executes a procedure same as the procedure of the AP 3a according to the second embodiment, generates the ND apparatus search request frame F31 (equivalent to “near ND search request” shown in FIG. 16) in the ND-apparatus searching unit 312b, and transmits the frame from the LAN transmitting unit 307.

The ND apparatus 1b that receives the ND apparatus search request frame F31 generates the ND apparatus search response frame F32 (equivalent to “near ND search response” shown in FIG. 16) in the ND-apparatus-search responding unit 111. The ND apparatus 1b acquires information (an own MAC address) stored by the own-MAC-address storing unit 108b and sets the acquired information as an SRC (a source address). The generated ND apparatus search response frame F32 is returned to the AP 3b at a request source (the AP 3b that transmits the ND apparatus search request frame F31).

Operation of the ND-apparatus-search responding unit 111 in acquiring information from the own-MAC-address storing unit 108b is explained with reference to FIG. 17. First, when an ND apparatus search request is received a plurality of times from the same AP, the own-MAC-address storing unit 108b responds with the same own MAC address. The own-MAC-address storing unit 108b checks whether a value same as an MAC address of a request source AP is stored in the request-source-AP storage area 182 (Step S31). When the value same as the MAC address of the request source AP is stored (Yes at Step S31), the own-MAC-address storing unit 108b returns a value (an own MAC address) stored in the own-MAC-address storage area 181 corresponding thereto to the ND-apparatus-search responding unit 111 (Step S32). On the other hand, when the value same as the MAC address of the request source AP is not stored in the request-source-AP storage area 182 (No at Step S31), the own-MAC-address storing unit 108b preferentially uses an own MAC address not used for ND apparatus search response. The own-MAC-address storing unit 108b checks whether an empty area is present in the search-request-source-AP storage area 182 (Step S33). When there is an empty area (Yes at Step S33), the own-MAC-address storing unit 108b returns a value of the own-MAC-address storage area 181 corresponding thereto to the ND-apparatus-search responding unit 111 (Step S34). When there are a plurality of empty areas, the own-MAC-address storing unit 108b selects any one of the empty areas. To indicate that the own MAC address is in use, the own-MAC-address storing unit 108b stores request source AP information in the search-request-source-AP storage area 182 (Step S36).

When all own MAC addresses are in use (No at Step S33), the own-MAC-address storing unit 108b selects an own MAC address used earliest and returns the selected own MAC address to the ND-apparatus-search responding unit 111 (Step S35). In this case, the own-MAC-address storing unit 108b also executes Step S6 and stores request source AP information in the search-request-source-AP storage area 182.

The own-MAC-address storing unit 108b updates information in the latest-search-time storage area 183 corresponding to the own MAC address returned to the ND-apparatus-search responding unit 111 with the present time (stores information concerning the present time in a corresponding area of the latest-search-time storage area 183) (Step S37).

The AP 3b that receives the ND apparatus search response frame F32, which is a response to the transmission of the ND apparatus search request frame F31, stores information (MAC address information) concerning the ND apparatus 1b included in the ND apparatus search response frame F32 in the ND-apparatus searching unit 312b in the same manner as the AP 3a.

A procedure of the STA 4b for searching for an ND apparatus is explained. The STA 4b executes a procedure same as the procedure of the STA 4a according to the second embodiment explained above and transmits the ND apparatus search request frame F31.

The ND apparatus 2b selects one of own MAC addresses and transmits the own MAC address with the ND apparatus search response frame F32 in a procedure same as the procedure of the ND apparatus 1b.

The STA 4b stores information concerning the ND apparatus 2b included in the ND apparatus search response frame F32 in the ND-apparatus searching unit 412b in the same manner as the STA 4a.

A procedure of the AP 3b and the STA 4b for exchanging remote ND apparatus information and notifying a near ND apparatus of the remote ND apparatus information is explained with reference to FIG. 16.

When a wireless link is established, the AP 3b and the STA 4b notify of each other of ND apparatus information stored in the ND-apparatus searching unit 312b and the ND-apparatus searching unit 412b, respectively (equivalent to “ND information exchange” shown in FIG. 16).

The AP 3b stores the information concerning the ND apparatus 2b notified from the STA 4b in the remote-ND-apparatus-information managing unit 314. The AP 3b generates a remote ND apparatus notification message (equivalent to “remote ND notification” shown in FIG. 16) including the information concerning the ND apparatus 2b in the remote-ND-apparatus notifying unit 315 and transmits the message to the near ND apparatus 1b. Further, the AP 3b generates a path learning packet in the path-learning-packet generating unit 316 and transmits the path learning packet to the L2 switch 5 such that an encapsulated data frame flows from the L2 switch 5 to the AP 3b. As the path learning packet, for example, an ARP (Address Resolution Protocol) packet with the ND apparatus 2b set as a transmission source is used.

When the remote ND apparatus notification message is received from the AP 3b, the ND apparatus 1b stores the notified information in the opposed-ND-apparatus-information storing unit 112.

As in the processing of the AP 3b, the STA 4b stores the information concerning the ND apparatus 1b notified from the AP 3b in the remote-ND-apparatus-information managing unit 414. The STA 4b generates a remote ND apparatus notification message (equivalent to “remote ND notification” shown in FIG. 16) including the information concerning the ND apparatus 1b in the remote-ND-apparatus-information notifying unit 415 and transmits the message to the near ND apparatus 2b. Further, the STA 4b generates a path learning packet in the path-learning-packet generating unit 416 and transmits the path learning packet to the L2 switch 6 such that an encapsulated data frame flows from the L2 switch 6 to the STA 4b. As the path learning packet, for example, an ARP packet with the ND apparatus 1b set as a transmission source is used.

When the remote ND apparatus notification message is received from the STA 4b, the ND apparatus 2b stores the notified information in the opposed-ND-apparatus-information storing unit 212.

Transmitting operation for traffic in an uplink direction flowing from the terminal apparatus 8 to the server apparatus 7 is explained. In the ND apparatus 2b, the encapsulating unit 204 encapsulates the data frame F41 and passes the data frame F41 to the copying unit 205b. The copying unit 205b copies the received encapsulated data frame, acquires information stored by the own-MAC-address storing unit 208b, and sets two own MAC addresses (M1_ND2b and M2_ND2b) as transmission source addresses of the encapsulated data frames. The copying unit 205b generates F42-1 and F42-2 by setting destination in two MAC addresses (M1_ND1b and M2_ND1b) of the remote ND apparatus 1b using information stored by the opposed-ND-apparatus-information storing unit 212.

One of the encapsulated frames is delivered to the STA 4b-1 from the L2 switch 6 according to a path learning result. The encapsulated frame F42-1 is delivered to the STA 4b-1. The STA 4b-1 does not decapsulate the received encapsulated frame and generates the wireless data frame F43-1 and transmits the wireless data frame F43-1 to the AP 3b-1 under connection.

On the other hand, one of the encapsulated frames is also delivered to the STA 4b-2 from the L2 switch 6 according to the path learning result. The STA 4b-2 does not decapsulate the received encapsulated frame and generates the wireless data frame F43-2 and transmits the wireless data frame F43-2 to the AP 3b-2.

The AP 3b generates an Ethernet (registered trademark) frame from a data frame received by the wireless receiving unit 301 and transmits the Ethernet frame to the ND apparatus 1b. The AP 3b does not encapsulate the frame.

The ND apparatus 1b selects one of the same frames received from the APs 3b-1 and 3b-2 in the selecting and combining unit 106 and passes the same frame to the decapsulating unit 107. The decapsulating unit 107 removes an encapsulated header from the received encapsulated data frame and transmits the data frame to the server apparatus 7.

One of MAC addresses of the ND apparatus 2b as transmission source information and address information of the terminal apparatus 8 as a traffic source are passed from the selecting and combining unit 106 to the ND-apparatus-terminal learning unit 113. the ND-apparatus-terminal learning unit 113 stores the received MAC address information of the ND apparatus 2b and address information of the terminal apparatus 8 in association with each other and prepares for transmitting operation for traffic in the opposite direction (downlink traffic).

Transmitting operation for traffic in a downlink direction flowing from the server apparatus 7 and the terminal apparatus 8 is substantially the same as the transmitting operation for the traffic in the uplink direction explained above. However, in the ND apparatus 1b, the transmitting operation is different in that the copying unit 105b acquires information stored by the ND-apparatus-terminal learning unit 113 using the address information of the terminal apparatus 8 as a key and determines a destination address of an encapsulated data frame using the acquired information. Operation of the copying unit 105b for determining a destination address is the same as the procedure of the copying unit 105 for acquiring address information of the AP 3-1 and address information of the AP 3-2 explained in the first embodiment.

FIG. 19 is a diagram of a state of transmitting operation for traffic in uplink/downlink directions flowing between the terminal apparatus 8 and the server apparatus 7.

As explained above, in this embodiment, a result of the search for a near ND apparatus performed by the AP and the STA is notified to the opposed remote ND apparatus via the wireless link, the L2 switch is caused to learn an MAC address of the remote ND apparatus, and termination of an encapsulated data frame is performed by only the ND apparatus. Consequently, in addition to the effects of the first and second embodiments, it is possible to reduce a transmission delay involved in encapsulation processing and decapsulation processing in the communication system.

### Fourth Embodiment

A communication system according to the fourth embodiment is explained. In the first to third embodiments, all the data frames transmitted by the server apparatus 7 are transmitted to the terminal apparatus 8. An embodiment in which an ND apparatus responds as a proxy of a terminal apparatus concerning an ARP request frame among data frames with the same system configuration as the first embodiment is explained below.

FIG. 20 is a diagram of a configuration example of an ND apparatus 1c disposed on a wireless base station side in the communication system according to the fourth embodiment. The ND apparatus 1c includes a filter/allocating unit 103c instead of the filter/allocating unit 103 of the ND apparatus 1 according to the first embodiment. Further, a proxy-ARP-response generating unit 114 configuring an ARP-packet generating unit is added. Other components are the same as those of the ND apparatus 1 according to the first embodiment. Therefore, the components are denoted by the same reference numerals and signs and explanation of the components is omitted.

A procedure of the ND apparatus 1c for responding as an ARP proxy is explained. When an ARP request frame is received, the filter/allocating unit 103c of the ND apparatus 1c allocates the frame to the proxy-ARP-response generating unit 114. When a frame other than the ARP request frame is received, the filter/allocating unit 103c performs operation same as the operation of the filter/allocating unit 103 according to the first embodiment.

When the ARP request frame is received, the proxy-ARP-response generating unit 114 inquires the transmitter-receiver-terminal learning unit 110 whether a resolution target address of the ARP request frame is included in learning content of the transmitter-receiver-terminal learning unit 110. When the ARP request frame is an MAC address inquiry of the terminal apparatus 8, because the transmitter-receiver-terminal learning unit 110 stores MAC address information, the proxy-ARP-response generating unit 114 generates an ARP response frame using the information.

In the example explained in this embodiment, the ND apparatus according to the first embodiment includes the filter/allocating unit 103c and the proxy-ARP-response generating unit 114. However, the present invention is not limited to this. The ND apparatuses according to the second and third embodiment can include the filter/allocating unit 103c and the proxy-ARP-response generating unit 114.

As explained above, in this embodiment, the ND apparatus responds to the ARP request frame as a proxy to prevent a multicast frame being transmitted in a wireless communication section. Consequently, in addition to the effects of the first to third embodiments, it is possible to reduce transmission load in the communication system.

### Fifth Embodiment

A communication system according to a fifth embodiment is explained. In the first to fourth embodiments, the operation of the ND apparatus for copying a data frame and delivering data frames to the transmitter and the receiver (the AP and the STA) frame by frame is explained. An embodiment in which a data frame is not copied and a plurality of APs or STAs are caused to deliver an encapsulated data frame in one transmission is explained below.

FIG. 21 is a diagram of a configuration example of an ND apparatus according to the fifth embodiment. As an example, a configuration example of an ND apparatus 1d disposed on a wireless base station side is shown. A configuration of an ND apparatus disposed in a mobile is the same. The ND apparatus 1d includes the LAN receiving unit 101, the LAN transmitting unit 102, the filter/allocating unit 103, an encapsulating unit 104d, the selecting and combining unit 106, the decapsulating unit 107, and the own-MAC-address storing unit 108. The LAN receiving unit 101, the LAN transmitting unit 102, the filter/allocating unit 103, the selecting and combining unit 106, the decapsulating unit 107, and the own-MAC-address storing unit 108 perform operation same as the operation of the components denoted by the same reference numerals and signs of the ND apparatus 1 according to the first embodiment. The ND apparatus 1d is a subset of the configuration of the ND apparatus 1. The encapsulating unit 104d has a function peculiar to this embodiment.

FIG. 22 is a diagram of a configuration example of a downlink data frame transmitted from the server apparatus 7 in the direction of the terminal apparatus 8 in the communication system according to the fifth embodiment. Reference sign F51 denotes a data frame transmitted from the server apparatus 7 to the ND apparatus 1d and F52 denotes a data frame transmitted from the ND apparatus 1d to the AP 3-1 and the AP 3-2.

FIG. 23 is a diagram of a sequence example in which an uplink data frame is transmitted from the terminal apparatus 8 in the direction of the server apparatus 7 and a sequence example in which a downlink data frame is transmitted from the server apparatus 7 in the direction of the terminal apparatus 8 in the communication system according to the fifth embodiment.

An operation of the ND apparatus 1d for transmitting an uplink data frame to the AP 3-1 and the AP 3-2 in transmitting operation for traffic in a downlink direction flowing from the server apparatus 7 to the terminal apparatus 8 is explained. The ND apparatus 1d recognizes an address of a multicast group to which the APs 3-1 and 3-2 belong. The encapsulating unit 104d stores information concerning the address. The L2 switch 5 recognizes the address of the multicast group to which the APs 3-1 and 3-2 belong and has ability for allocating frames according to the information concerning the address.

In the ND apparatus 1d, the encapsulating unit 104 encapsulates the data frame F51 received from the server apparatus 7 and sets a transmission source address using information stored by the own-MAC-address storing unit 108. The encapsulating unit 104 generates the encapsulated data frame F52 with a destination address set to the address of the multicast group to which the APs 3-1 and 3-2 belong. The generated encapsulated data frame F52 is transmitted from the LAN transmitting unit 102.

The L2 switch 5 transfers the encapsulated data frame F52 to the APs 3-1 and 3-2 belonging to the multicast group according to destination address information of the encapsulated data frame F52 transmitted from the ND apparatus 1d.

Operation after the encapsulated data frame F52 reaches the APs 3-1 and 3-2 is the same as the operation in the first embodiment explained above.

For transmitting operation for traffic in an uplink direction flowing from the terminal apparatus 8 to the server apparatus 7, the multicast address can also be used concerning encapsulated data transfer between the ND apparatus disposed in the mobile and the STAs 4-1 and 4-2.

When the ND apparatuses according to the second to fourth embodiments encapsulate a data frame, the multicast address can be set as a destination address of the data frame.

As explained above, in this embodiment, the ND apparatus does not copy a data frame. The multicast address is used for destination information of an encapsulated frame. The ND apparatus only has to transmit an encapsulated data frame once. Consequently, in addition to the effects of the first to fourth embodiments, it is possible to reduce transmission load of the ND apparatus.

### Sixth Embodiment

A communication system according to a sixth embodiment is explained. In the third embodiment explained above, each of the ND apparatuses has two MAC addresses. The operation for properly using the MAC addresses according to a communication path is explained. An embodiment in which the MAC addresses of each of ND apparatuses are reduced to one MAC address but, instead, a communication path is properly used by using a VLAN (Virtual LAN) is explained.

FIG. 24 is a diagram of a configuration example of the communication system according to the sixth embodiment. The communication system according to this embodiment includes a network diversity apparatus (ND apparatus) 1e on a wireless base station side, an ND apparatus 2 disposed in a mobile, APs 3e-1 to 3e-3, STAs 4e-1 and 4e-2, and L2 switches 5e and 6e that support the VLAN.

FIG. 25 is a diagram of a configuration example of an ND apparatus according to the sixth embodiment. As an example, a configuration example of the ND apparatus 1e disposed on the wireless base station side is shown. A configuration of an ND apparatus disposed in the mobile is the same. In the ND apparatus 1e, the ND-apparatus-terminal learning unit 113 is deleted from the ND apparatus 1b (see FIG. 12-1) according to the third embodiment. The ND apparatus 1e includes an encapsulating unit 104e, a copying unit 105e, and the own-MAC-address storing unit 108 instead of the encapsulating unit 104, the copying unit 105b, and the own-MAC-address storing unit 108b. Other components are the same as those of the ND apparatus 1b according to the third embodiment. Therefore, the components are denoted by the same reference numerals and signs and explanation of the components is omitted. The own-MAC-address storing unit 108 is the same as the own-MAC-address storing unit 108 included in the ND apparatus 1 according to the first embodiment.

The copying unit 105e and the LAN transmitting unit 102 configure an uplink-data-frame copying and transmitting unit and a downlink-data-frame copying and transmitting unit described in claim 8, a downlink-data-frame copying and transmitting unit described in claim 15, and an uplink-data-frame copying and transmitting unit described in claim 16. The selecting and combining unit 106, the decapsulating unit 107, and the LAN transmitting unit 102 configure an uplink-data-frame selecting and transmitting unit and a downlink-data-frame selecting and transmitting unit described in claim 8, a downlink-data-frame selecting and transmitting unit described in claim 15, and an uplink-data-frame selecting and transmitting unit described in claim 16.

FIG. 26 is a diagram of a configuration example of APs (an AP 3e-1 to an AP 3e-3; the APs according to this embodiment are hereinafter collectively referred to as AP 3e) according to the sixth embodiment. The AP 3e-1 to the AP 3e-3 have a configuration in which the path-learning-packet generating unit 316 is deleted from the APs 3b-1 to 3b-3 according to the third embodiment (see FIG. 13). Other components are the same as those of the APs 3b-1 to 3b-3. Therefore, the components are denoted by the same reference numerals and signs and explanation of the components is omitted.

FIG. 27 is a diagram of a configuration example of STAs (an STA 4e-1 and an STA 4e-2; the STAs according to this embodiment are hereinafter correctively referred to as STA 4e) according to the sixth embodiment. The STAs 4e-1 and 4e-2 have a configuration in which the path-learning-packet generating unit 416 is deleted from the STAs 4b-1 and 4b-2 according to the third embodiment (see FIG. 14). Other components are the same as those of the STAs 4b-1 and 4b-2. Therefore, the components are denoted by the same reference numerals and signs and explanation of the components is omitted.

FIG. 28 is a diagram of a configuration example of an uplink data frame transmitted from the terminal apparatus 8 in the direction of the server apparatus 7 in the communication system according to the sixth embodiment. In FIG. 28, reference numeral F61 denotes a data frame transmitted from the terminal apparatus 8 to the ND apparatus 2e, F62-1 denotes a data frame transmitted from the ND apparatus 2e to the STA 4e-1, F62-2 denotes a data frame transmitted from the ND apparatus 2e to the STA 4e-2, F63-1 denotes a data frame transmitted from the STA 4e-1 to the AP 3e-1, F63-2 denotes a data frame transmitted from the STA 4e-2 to the AP 3e-2, F64-1 denotes a data frame transmitted from the AP 3e-1 to the ND apparatus 1e, F64-2 denotes a data frame transmitted from the AP 3e-2 to the ND apparatus 1e, and F65 denotes a data frame transmitted from the ND apparatus 1e to the server apparatus 7. In FIG. 28, reference signs V1 and V2 denote a VLAN identifier #1 and a VLAN identifier #1, respectively.

Transmitting operation for traffic in an uplink direction flowing from the terminal apparatus 8 to the server apparatus 7 is explained.

The L2 switch 5e recognizes for which of a plurality of communication paths the connected APs 3e-1 to 3e-3 are used and recognizes a VLAN identifier for each of the paths. For example, in the system according to this embodiment (see FIG. 24), if communication between the AP 3e-3 and the STA 4e-1 is used as an alternative when communication between the AP 3e-1 and the STA 4e-1 is interrupted, the AP 3e-1 and the AP 3e-3 belong to the same VLAN. Like the L2 switch 5e, the L2 switch 6e recognizes the VLAN identifier for each of the paths. The ND apparatuses 1e and 2e recognize the VLAN identifier for each of the paths. The copying unit 105e stores information concerning the VLAN identifier.

In the ND apparatus disposed in the mobile, the encapsulating unit 104e encapsulates the data frame F61 received from the terminal apparatus 8. The copying unit 105e copies the encapsulated data frame and sets own MAC addresses as transmission source addresses of the encapsulated data frames suing information stored by the own-MAC-address storing unit 108. The copying unit 105e sets an MAC address of the ND apparatus 1e which is a remote ND apparatus, as a destination address using information stored by the opposed-ND-apparatus-information storing unit 112. The copying unit 105e sets values peculiar to two paths in VLAN identifier areas of encapsulated headers to thereby generate encapsulated data frames F62-1 and F62-2. The generated encapsulated data frames F62-1 to F62-2 are transmitted from the LAN transmitting unit 102.

The L2 switch 6e allocates encapsulated data frames received from the ND apparatus 2e according to VLAN identifiers of the encapsulated data frames. Specifically, the encapsulated data frame F62-1 is passed to the STA 4e-1 and the encapsulated data frame F62-2 is passed to the STA 4e-2.

For transmitting operation for traffic in a downlink direction flowing from the server apparatus 7 to the terminal apparatus 8, transmission paths can be identified according to VLAN identifiers in the same manner.

As explained above, in this embodiment, communication paths are properly used according to VLAN identifiers. Consequently, even if there is only one MAC address allocated to the ND apparatuses, it is possible to obtain the same effect as the third embodiment.

### Seventh Embodiment

A communication system according to a seventh embodiment is explained. In the first to sixth embodiments, network diversity operation in the system configuration in which the mobile includes a plurality of STAs is explained. However, the communication system can have a system configuration in which a single STA performs communication with a plurality of APs by, for example, sharing the same change in a time division manner according to CSMA/CA (Carrier Sense Multiple Access with Collision Avoidance) or the like.

In the first to sixth embodiments, the communication system in which the ND apparatus and the L2 switch on the mobile side are independent is explained. However, an ND apparatus can also perform the L2 switch function, whereby an STA and the ND apparatus are integrated.

FIG. 29 is a diagram of a configuration example of the inside of a mobile that performs communication with a plurality of APs using a single STA. FIG. 30 is a diagram of a configuration example of the inside of a mobile in which an apparatus obtained by integrating an STA and an ND apparatus is disposed.

As explained above, in this embodiment, a single STA is allowed to independently communicate with a plurality of APS by time division or the like. Therefore, it is possible to obtain the same effect as the embodiments explained above simply by arranging the single STA in the mobile. An ND apparatus also having the L2 switch function is used to integrate an STA and the ND apparatus. Therefore, it is possible to obtain the same effect as the embodiments by arranging an only apparatus (an apparatus obtained by integrating the STA and the ND apparatus) in the mobile.

### INDUSTRIAL APPLICABILITY

As explained above, the communication system, the communication apparatus, the wireless base station, and the wireless terminal station according to the present invention is suitable for realizing seamless communication using network diversity communication.

1-19. (canceled)

20: A communication system including a plurality of wireless base stations, a first network diversity apparatus connected to the wireless base stations, and a mobile including a plurality of wireless terminal stations connected to any one of the wireless base stations by wireless and connected to a single terminal apparatus by wire and a second network diversity apparatus connected to the wireless terminal stations, wherein
the first network diversity apparatus includes
a downlink-data-frame copying and transmitting unit that copies a downlink data frame addressed to the terminal apparatus and transmits downlink data frames obtained by the copying processing to the terminal apparatus through different base stations, respectively, and
an uplink-data-frame selecting and transmitting unit that transmits, when a plurality of uplink data frames having same content are received through different wireless base stations, respectively, any one uplink data frame selected out of the uplink data frames to a destination thereof, and
the second network diversity apparatus includes
an uplink-data-frame copying and transmitting unit that copies an uplink data frame received from the terminal apparatus and transmits uplink data frames obtained by the copying processing to a destination thereof through different wireless terminal stations, respectively, and
a downlink-data-frame selecting and transmitting unit that transmits, when a plurality of downlink data frames having same content are received through different wireless terminal stations, respectively, any one downlink data frame selected out of the downlink data frames to the terminal apparatus.

21: A communication system including a plurality of wireless base stations, a first network diversity apparatus connected to the wireless base stations, and a mobile including a plurality of wireless terminal stations connected to any one of the wireless base stations by wireless and connected to a single terminal apparatus by wire and a second network diversity apparatus connected to the wireless terminal stations, wherein
the first network diversity apparatus includes
a downlink-data-frame copying and transmitting unit that copies a downlink encapsulated data frame generated by encapsulating a downlink data frame addressed to the terminal apparatus and transmits downlink encapsulated data frames obtained by executing the copying processing to the second network diversity apparatus through different base stations, respectively, and
an uplink-data-frame selecting and transmitting unit that decapsulates, when a plurality of uplink encapsulated data frames having same content are received through different wireless base stations, respectively, any one uplink encapsulated data frame selected out of the uplink encapsulated data frames and transmits obtained uplink data frame to a destination thereof, and
the second network diversity apparatus includes
an uplink-data-frame copying and transmitting unit that copies an uplink encapsulated data frame generated by encapsulating an uplink data frame received from the terminal apparatus and transmits uplink encapsulated data frames obtained by executing the copying processing to the first network diversity apparatus through different wireless terminal stations, respectively, and
a downlink-data-frame selecting and transmitting unit that transmits, when a plurality of downlink encapsulated data frames having same content are received through different wireless terminal stations, respectively, any one downlink encapsulated data frame selected out of the downlink encapsulated data frames to the terminal apparatus.

22: The communication system according to claim 21, wherein
the wireless base station includes
a wireless-terminal-station-address storing unit that stores address information of a transmission source terminal apparatus included in an uplink wireless data frame generated and transmitted by the wireless terminal station and address information of the wireless terminal station in association with each other,
an uplink-encapsulated-data-frame transmitting unit that transmits an uplink encapsulated data frame generated based on the uplink wireless data frame to the first network diversity apparatus, and
a downlink-wireless-data-frame transmitting unit that transmits a downlink wireless data frame generated based on a downlink encapsulated data frame generated and transmitted by the first network diversity apparatus to a transmission destination wireless terminal station determined based on address information of a destination terminal apparatus included in the downlink encapsulated data frame and information stored by the wireless-terminal-station-address storing unit, and
the wireless terminal station includes
a downlink-encapsulated-data-frame transmitting unit that transmits a downlink encapsulated data frame generated based on a downlink wireless data frame received from the wireless base station to the second network diversity apparatus, and
an uplink-wireless-data-frame transmitting unit that transmits an uplink wireless data frame generated based on an uplink encapsulated data frame received from the second network diversity apparatus to a wireless base station under connection.

23: The communication system according to claim 21, wherein
the wireless base station includes
a first network-diversity-apparatus searching unit that broadcast-transmits, when the own station is started, a network diversity apparatus search request frame for searching for a network diversity apparatus to be connected and stores address information of a network diversity apparatus that transmits a response frame to the network diversity apparatus search request frame,
a wireless-terminal-station-address storing unit that stores address information of a transmission source terminal apparatus included in an uplink wireless data frame generated and transmitted by the wireless terminal station and address information of the wireless terminal station in association with each other,
an uplink-encapsulated-data-frame transmitting unit that sets address information stored by the first network-diversity-apparatus searching unit as a destination address of an uplink encapsulated data frame generated based on the uplink wireless data frame generated and transmitted by the wireless terminal station and transmits the uplink encapsulated data frame to a destination thereof, and
a downlink-wireless-data-frame transmitting unit that transmits a downlink wireless data frame generated based on a downlink encapsulated data frame received from the first network diversity apparatus to a transmission destination wireless terminal station determined based on address information of a destination terminal apparatus included in the downlink encapsulated data frame and information stored by the wireless-terminal-station-address storing unit, and
the wireless terminal station includes
a second network-diversity-apparatus searching unit that broadcast-transmits, when the own station is started, a network diversity apparatus search request frame for searching for a network diversity apparatus to be connected and stores address information of a network diversity apparatus that transmits a response frame to the network diversity apparatus search request frame,
a downlink-encapsulated-data-frame transmitting unit that sets address information stored by the second network-diversity-apparatus searching unit as a destination address of a downlink encapsulated data frame generated based on a downlink wireless data frame received from the wireless base station and transmits the downlink encapsulated data frame, and
an uplink-wireless-data-frame transmitting unit that transmits an uplink wireless data frame generated based on an uplink encapsulated data frame received from the second network diversity apparatus to a wireless base station under connection.

24: The communication system according to claim 21, wherein
the first network diversity apparatus further includes a base-station-address storing unit that stores address information of a transmission source terminal apparatus included in an uplink data frame obtained by executing the decapsulation processing and address information of a wireless base station that transmits the uplink encapsulated data frame, and
the downlink-data-frame copying and transmitting unit determines, when a downlink encapsulated data frame is copied, a destination address set in copied downlink encapsulated data frame based on a destination address of the downlink data frame and information stored by the base-station-address storing unit.

25: The communication system according to claim 24, wherein the first network diversity apparatus further includes an ARP-response-packet generating unit that generates, when an address resolution protocol packet for performing path learning is received, a response packet to the address resolution protocol packet on behalf of a wireless base station connected to the first network diversity apparatus based on information stored by the base-station-address storing unit.

26: The communication system according to claim 21, wherein
the downlink-data-frame copying and transmitting unit does not copy the downlink encapsulated data frame, sets a multicast address, which is used during multicast transmission to a wireless base station connected to the first network diversity apparatus, as a destination address of the downlink encapsulated data frame, and transmits the downlink encapsulated data frame, and
the uplink-data-frame copying transmitting unit does not copy the uplink encapsulated data frame, sets a multicast address, which is used during multicast transmission to a wireless terminal station connected to the second network diversity apparatus, as a destination address of the uplink encapsulated data frame, and transmits the uplink encapsulated data frame.

27: A communication system including a plurality of wireless base stations, a first network diversity apparatus connected to the wireless base stations, and a mobile including a plurality of wireless terminal stations connected to any one of the wireless base stations by wireless and connected to a single terminal apparatus by wire and a second network diversity apparatus connected to the wireless terminal stations, wherein
the first network diversity apparatus includes
a downlink-data-frame copying and transmitting unit that copies a downlink encapsulated data frame generated by encapsulating a downlink data frame addressed to the terminal apparatus, sets any ones of a plurality of media access control addresses, which are allocated to the first network diversity apparatus, as source addresses of downlink encapsulated data frames obtained by executing the copying processing such that the media access control addresses do not overlap each other, sets any ones of a plurality of media access control addresses, which are acquired in advance and allocated to the second network diversity apparatus, as destination addresses of the downlink data frame such that the media access control addresses do not overlap each other, and transmits the downlink encapsulated data frames through different wireless base stations, respectively, and
an uplink-data-frame selecting and transmitting unit that selects, when a plurality of uplink encapsulated data frames having same content are received through different wireless base stations, respectively, any one of the received uplink encapsulated data frames and transmits an uplink data frame generated by decapsulating selected uplink encapsulated data frame to a destination thereof, and
the second network diversity apparatus includes
an uplink-data-frame copying and transmitting unit that copies an uplink encapsulated data frame generated by encapsulating an uplink data frame received from the terminal apparatus, sets any ones of a plurality of media access control addresses, which are allocated to the second network diversity apparatus, as source addresses of uplink encapsulated data frames obtained by executing the copying processing such that the media access control addresses do not overlap each other, sets any ones of a plurality of media access control addresses, which are acquired in advance and allocated to the first network diversity apparatus, as destination addresses of the uplink data frames such that the media access control addresses do not overlap each other, and transmits the uplink encapsulated data frames through the different wireless terminal stations, respectively, and
a downlink-data-frame selecting and transmitting unit that selects, when a plurality of downlink encapsulated data frames having same content are received through different wireless terminal stations, respectively, any one of the received downlink encapsulated data frames and transmits a downlink data frame generated by decapsulating selected downlink encapsulated data frame to a destination thereof.

28: The communication system according to claim 27, wherein
the wireless base station includes
a first network-diversity-apparatus searching unit that broadcast-transmits, when the own station is started, a network diversity apparatus search request frame for searching for a network diversity apparatus to be connected and stores address information of a network diversity apparatus that transmits a response frame to the network diversity apparatus search request frame,
a first address-information exchanging unit that notifies, when a link is established between the wireless base station and a wireless terminal station, the wireless terminal station of the address information stored by the first network-diversity-apparatus searching unit and acquires address information of a network diversity apparatus connected to the wireless terminal station from the wireless terminal station, and
a first address-information notifying unit that notifies a network diversity apparatus connected to the wireless base station of the address information of the network diversity apparatus connected to the wireless terminal station acquired by the first address-information exchanging unit,
the wireless terminal station includes
a second network-diversity-apparatus searching unit that broadcast-transmits, when the own station is started, a network diversity apparatus search request frame for searching for a network diversity apparatus to be connected and stores address information of a network diversity apparatus that transmits a response frame to the network diversity apparatus search request frame,
a second address-information exchanging unit that notifies, when a link is established between the wireless terminal station and a wireless base station, the wireless base station of the address information stored by the second network-diversity-apparatus searching unit and acquires address information of a network diversity apparatus connected to the wireless base station from the wireless base station, and
a second address-information notifying unit that notifies a network diversity apparatus connected to the wireless terminal station of the address information of the network diversity apparatus connected to the wireless base station acquired by the second address-information exchanging unit, and
the downlink-data-frame copying and transmitting unit sets the address information, which is notified from the first address-information notifying unit, as a destination address of the downlink encapsulated data frame, and the uplink-data-frame copying and transmitting unit sets the address information, which is notified from the second address-information notifying unit, as a destination address of the uplink encapsulated data frame.

29: The communication system according to claim 27, wherein
the downlink-data-frame copying and transmitting unit does not copy the downlink encapsulated data frame, sets a multicast address, which is used during multicast transmission to a wireless base station connected to the first network diversity apparatus, as a destination address of the downlink encapsulated data frame, and transmits the downlink encapsulated data frame, and
the uplink-data-frame copying transmitting unit does not copy the uplink encapsulated data frame, sets a multicast address, which is used during multicast transmission to a wireless terminal station connected to the second network diversity apparatus, as a destination address of the uplink encapsulated data frame, and transmits the uplink encapsulated data frame.

30: A communication system including a plurality of wireless base stations, a first network diversity apparatus connected to the wireless base stations, and a mobile including a plurality of wireless terminal stations connected to any one of the wireless base stations by wireless and connected to a single terminal apparatus by wire and a second network diversity apparatus connected to the wireless terminal stations, wherein
the first network diversity apparatus includes
a downlink-data-frame copying and transmitting unit that copies a downlink encapsulated data frame generated by encapsulating a downlink data frame addressed to the terminal apparatus, sets media access control addresses, which are acquired in advance and allocated to the second network diversity apparatus, as destination addresses of downlink encapsulated data frames obtained by executing the copying processing, sets virtual local area network identifiers of wireless base stations, which are acquired in advance, in the downlink encapsulated data frames such that the downlink encapsulated data frames are transmitted to different wireless base stations, respectively, and transmits the downlink encapsulated data frames, and
an uplink-data-frame selecting and transmitting unit that selects, when a plurality of uplink encapsulated data frames having same content are received through different wireless base stations, respectively, any one of received uplink encapsulated data frames and transmits an uplink data frame generated by decapsulating selected uplink encapsulated data frame to a destination thereof, and
the second network diversity apparatus includes
an uplink-data-frame copying and transmitting unit that copies an uplink encapsulated data frame generated by encapsulating an uplink data frame received from the terminal apparatus, sets media access control addresses, which are acquired in advance and allocated to the first network diversity apparatus, as destination addresses of uplink encapsulated data frames obtained by executing the copying processing, sets virtual local area network identifiers of wireless terminal stations, which are acquired in advance, in the uplink encapsulated data frames such that the uplink encapsulated data frames are transmitted to different wireless terminal stations, respectively, and transmits the uplink encapsulated data frames, and
a downlink-data-frame selecting and transmitting unit that selects, when a plurality of downlink encapsulated data frames having same content are received through different wireless terminal stations, respectively, any one of received downlink encapsulated data frames and transmits a downlink data frame generated by decapsulating the selected downlink encapsulated data frame to a destination thereof.

31: The communication system according to claim 30, wherein
the wireless base station includes
a first network-diversity-apparatus searching unit that broadcast-transmits, when the own station is started, a network diversity apparatus search request frame for searching for a network diversity apparatus to be connected and stores address information of a network diversity apparatus that transmits a response frame to the network diversity apparatus search request frame,
a first address-information exchanging unit that notifies, when a link is established between the wireless base station and a wireless terminal station, the wireless terminal station of the address information stored by the first network-diversity-apparatus searching unit and acquires address information of a network diversity apparatus connected to the wireless terminal station from the wireless terminal station, and
a first address-information notifying unit that notifies a network diversity apparatus connected to the wireless base station of the address information of the network diversity apparatus connected to the wireless terminal station acquired by the first address-information exchanging unit,
the wireless terminal station includes
a second network-diversity-apparatus searching unit that broadcast-transmits, when the own station is started, a network diversity apparatus search request frame for searching for a network diversity apparatus to be connected and stores address information of a network diversity apparatus that transmits a response frame to the network diversity apparatus search request frame,
a second address-information exchanging unit that notifies, when a link is established between the wireless terminal station and a wireless base station, the wireless base station of the address information stored by the second network-diversity-apparatus searching unit and acquires address information of a network diversity apparatus connected to the wireless base station from the wireless base station, and
a second address-information notifying unit that notifies a network diversity apparatus connected to the wireless terminal station of the address information of the network diversity apparatus connected to the wireless base station acquired by the second address-information exchanging unit, and
the downlink-data-frame copying and transmitting unit sets the address information, which is notified from the first address-information notifying unit, as a destination address of the downlink encapsulated data frame, and the uplink-data-frame copying and transmitting unit sets the address information, which is notified from the second address-information notifying unit, as a destination address of the uplink encapsulated data frame.

32: The communication system according to claim 30, wherein
the downlink-data-frame copying and transmitting unit does not copy the downlink encapsulated data frame, sets a multicast address, which is used during multicast transmission to a wireless base station connected to the first network diversity apparatus, as a destination address of the downlink encapsulated data frame, and transmits the downlink encapsulated data frame, and
the uplink-data-frame copying transmitting unit does not copy the uplink encapsulated data frame, sets a multicast address, which is used during multicast transmission to a wireless terminal station connected to the second network diversity apparatus, as a destination address of the uplink encapsulated data frame, and transmits the uplink encapsulated data frame.

33: A communication apparatus that is configured to be connected to a plurality of wireless base stations, transmits uplink encapsulated data frames received from the wireless base stations to destinations thereof, and transmits a downlink data frame received from a connected network to a destination terminal apparatus thereof through the wireless base stations, the communication apparatus comprising:
a downlink-data-frame copying and transmitting unit that copies a downlink encapsulated data frame generated by encapsulating the downlink data frame received from the network and transmits downlink encapsulated data frames obtained by executing the copying processing to different wireless base stations, respectively; and
an uplink-data-frame selecting and transmitting unit that selects, when a plurality of uplink encapsulated data frames having same content are received through different wireless base stations, respectively, any one of received uplink encapsulated data frames and transmits an uplink data frame generated by decapsulating selected uplink encapsulated data frame to a destination thereof.

34: The communication apparatus according to claim 33, further comprising a base-station-address storing unit that stores address information of a transmission source terminal apparatus included in an uplink data frame obtained by executing the decapsulation processing and address information of a wireless base station that transmits the uplink encapsulated data frame, wherein
the downlink-data-frame copying and transmitting unit determines, when a downlink encapsulated data frame is copied, a destination address set in copied downlink encapsulated data frame based on a destination address of the downlink data frame and information stored by the base-station-address storing unit.

35: The communication apparatus according to claim 34, further comprising an address resolution protocol response packet generating unit that generates, when an address resolution protocol packet for performing path learning is received, a response packet to the address resolution protocol packet on behalf of a wireless base station connected to the first network diversity apparatus based on information stored by the base-station-address storing unit.

36: A communication apparatus that is configured to be connected to a plurality of wireless base stations and transmits uplink encapsulated data frames received from the wireless base stations and a downlink data frame received from a connected network to destinations thereof, the communication apparatus comprising:
a downlink-data-frame copying and transmitting unit that copies a downlink encapsulated data frame generated by encapsulating a downlink data frame received from the network, sets media access control addresses, which are acquired in advance and allocated to a communication partner apparatus, as destination addresses of downlink encapsulated data frames obtained by executing the copying processing, sets virtual local area network identifiers of the wireless base stations, which are acquired in advance, in the downlink encapsulated data frames such that the downlink encapsulated data frames are transmitted through different wireless base stations, respectively, and transmits the downlink encapsulated data frames; and
an uplink-data-frame selecting and transmitting unit that selects, when a plurality of uplink encapsulated data frames having same content are received through different wireless base stations, respectively, any one of received uplink encapsulated data frames and transmits an uplink data frame generated by decapsulating selected uplink encapsulated data frame to a destination thereof.

37: A communication apparatus that is configured to be connected to a plurality of wireless terminal stations and transmits downlink encapsulated data frames received from the wireless terminal stations and an uplink data frame received from a connected terminal apparatus to destinations thereof, the communication apparatus comprising:
an uplink-data-frame copying and transmitting unit that copies an uplink encapsulated data frame generated by encapsulating an uplink data frame received from the terminal apparatus, sets media access control addresses, which are acquired in advance and allocated to a communication partner apparatus, as destination addresses of uplink encapsulated data frames obtained by executing the copying processing, sets virtual local area network identifiers of the wireless terminal stations, which are acquired in advance, in the uplink encapsulated data frames such that the uplink encapsulated data frames are transmitted through different wireless terminal stations, respectively, and transmits the uplink encapsulated data frames; and
a downlink-data-frame selecting and transmitting unit that selects, when a plurality of downlink encapsulated data frames having same content are received through different wireless terminal stations, respectively, any one of received downlink encapsulated data frames and transmits a downlink data frame generated by decapsulating selected downlink encapsulated data frame to a destination thereof.

38: A wireless base station comprising:
a wireless-terminal-station-address storing unit that stores address information of a transmission source terminal apparatus included in an uplink wireless data frame received from a wireless terminal station connected by wireless and address information of the wireless terminal station in association with each other; and
a downlink-wireless-data-frame transmitting unit that transmits a downlink wireless data frame generated based on a downlink encapsulated data frame received from a network diversity apparatus to a wireless terminal station determined based on address information of a destination terminal apparatus included in the downlink data frame and information stored by the wireless-terminal-station-address storing unit.

39: A wireless base station comprising:
a network-diversity-apparatus searching unit that broadcast-transmits, when the wireless base station is started, a network diversity apparatus search request frame for searching for a network diversity apparatus to be connected and stores address information of a network diversity apparatus that transmits a response frame to the network diversity apparatus search request frame;
a wireless-terminal-station-address storing unit that stores address information of a transmission source terminal apparatus included in an uplink wireless data frame received from a wireless terminal station and address information of the wireless terminal station in association with each other;
an uplink-encapsulated-data-frame transmitting unit that sets address information stored by the network-diversity-apparatus searching unit as a destination address of an uplink encapsulated data frame generated based on the uplink wireless data frame and transmits the uplink encapsulated data frame; and
a downlink-wireless-data-frame transmitting unit that transmits a downlink wireless data frame generated based on a downlink encapsulated data frame received from the network diversity apparatus, which is connected to the own station, to a transmission destination wireless terminal station determined based on address information of a destination terminal apparatus included in the downlink data frame and information stored by the wireless-terminal-station-address storing unit.

40: A wireless terminal station comprising:
a network-diversity-apparatus searching unit that broadcast-transmits, when the wireless terminal station is started, a network diversity apparatus search request frame for searching for a network diversity apparatus to be connected and stores address information of a network diversity apparatus that transmits a response frame to the network diversity apparatus search request frame and is disposed on a mobile on which the wireless terminal station is disposed; and
a downlink-encapsulated-data-frame transmitting unit that sets address information stored by the network-diversity-apparatus searching unit as a destination address of a downlink encapsulated data frame generated based on a downlink wireless data frame received from a wireless base station and transmits the downlink encapsulated data frame.
